(19) United States
(12) Patent Application Publication
(10) Pub. No.: US 2008/0189789 A1
(43) Pub. Date: Aug. 7, 2008

(54) System, method and apparatus for the detection and capturing of technological crime instances

(76) Inventor: Elaine Lamontagne, Calgary (CA)

Correspondence Address: ASHKAN NAJAFI, P.A., 6817 SOUTHPOINT PARKWAY, SUITE 2301, JACKSONVILLE, FL, 32216, US

(21) Appl. No.: 11/701,909

(22) Filed: Feb. 1, 2007

(51) Int. Cl. G06F 7/04

(52) U.S. Cl. 726/26

(57) ABSTRACT

A system, method and apparatus for the detection, verification, capturing, reporting and locating of technological crime instances occurring through the use of consumer electronic devices, including an custom software application comprised of modules, a development environment and a real time production environment. In one embodiment the software/firmware detection, verification and capturing rules, definitions and instructions are created, maintained and managed in the development environment for transmittal and for use in the real time production environment existing on media, in content and on one or more hardware chips installed in consumer electronic devices. The system, method and apparatus includes capabilities to detect, capture, report and provide location information of technological crimes such as child pornography, online identity theft, spamming, disc piracy, screener piracy, camcorder piracy and internet piracy, and a method of generating revenue for industries affected by piracy.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a system, method and apparatus for detecting, capturing, locating and reporting of technological crime instances occurring through the use of consumer electronic devices.

2. Prior Art

The widespread problem of technological crimes through the use of consumer electronic devices has in recent years escalated to critical levels. Technological crimes such as piracy, child pornography, online identity theft and spamming are already rampant and continue to grow further out of control due to the advent of newer, cheaper consumer electronic technology. Government, industries, law enforcement agencies, institutions and associations currently fighting technological crimes are restricted in their successes due to the public availability of tools such as masking technologies, content protection removal technologies, and security removal technologies.

Technological crimes occurring through the use of consumer electronic devices cause societal frustration, harm to the innocent, financial losses and grief for government, industry and law enforcement agencies. All technological crimes exploit the innocent in one form or another. The US government is currently using technologies such as MATRIX and NORA for intelligence gathering and entity identification and tracking. MATRIX capabilities include the tracking of individuals through means such as law enforcement alias databases, credit card usage and travel bookings. NORA capabilities include the ability to associate one or more persons through non-obvious relationships, such as phone numbers or addresses indicated on credit and/or employment applications. Technologies such as these are in demand by the US government to aid them in protecting homeland security and in their war against terrorism.

### Child Pornography

Wide distribution of child pornography via the Internet is rampant. As of 2005, child pornography web-sites incur an average of 140,000 hits per month, including viewing and downloading. The task of locating and capturing child pornographers is an on-going battle. Through the use of technologies such as web crawlers, agencies and associations are able to track web-sites hosting child pornography. Those web-sites also frequently rotate server locations and use masking technologies to hide their true internet protocol addresses. Law enforcement agencies and associations such as NECMEC, Cybertipline and Child-Abuse.com continue to work exhaustingly in the daily and ever changing task of tracking and monitoring child pornography web-sites and activities occurring over the Internet.

It is the inventors' opinion that in order for a child pornography solution to be truly effective it must include a system, method and apparatus in which to remove the cloaking and masking capabilities of child pornography web servers and their content viewers; thereby aiding Government, Law Enforcement Agencies and Child Pornography Associations in identifying and locating child pornographers.

### Spamming

Wide distribution of email via the Internet is out of control. The average email account receives 25 to 100 junk emails each and every day. Some forms of control have been implemented by Internet Service Providers, however, ever changing technology allows spammers to defeat those control measures and continue to breach Internet Service Providers security in order to hijack valid email accounts and utilize them for the mass distribution of spam mail. Legislation is currently in place in the US to address spamming and is in the process of becoming a chargeable offense.

It is the inventors' opinion that in order for a spamming solution to be truly effective it must include a system, method and apparatus in which to identify consistent patterns of mass emails using various and multiple email identities from the same internet protocol address or network interface communications identifier; thereby aiding Government, Law Enforcement Agencies and Internet Service Providers in identifying and locating persons performing spamming.

### Identity Theft

Theft of a person's identity over the Internet is increasing in frequency. Theft of social security numbers, credit card numbers and any other personal or financial information is increasing at an alarming rate. The Federal Trade Commission through the Identity Theft Data Clearinghouse reports that one in eight families are victims of identity theft. Identity Theft 911 reports that approximately 3.6 million cases of identity theft or fraud occurred in 2002, however, even their own projections could not take into consideration the number of victims not reporting crimes to the credit reporting agencies or those individuals unaware that they had already been victimized.

It is the inventors' opinion that in order for an online identity theft solution to be truly effective it must include a system, method and apparatus in which to identify consistent patterns of confidential information, repeatedly or continuously occurring from the same internet protocol address or network interface communication identifier; thereby aiding Government, Law Enforcement Agencies and Internet Service Providers in identifying and locating persons performing online identity theft.

### Piracy

Piracy is a large-scale problem spanning a wide area enterprise comprised mainly of the motion picture, recording and software industries, and the government. Government and industries continue to look for ways to combat the many forms of piracy. Piracy has been identified and reported as a source of funding for terrorist groups such as Hezebollah and Hamas. While government and industry currently have methods in place to track and estimate piracy activities and losses, there remain areas that they are yet unable to accurately track and therefore are also unable to estimate actual losses. Piracy occurs in many forms and at many levels including: Screener piracy—screening or marketing copy is illegitimately copied; Camcorder piracy—person with a camcorder attends a premier showing of a movie and videotapes it; Disc pirating—the mass replication of copyrighted digital content for the purpose of illegal sale; Internet piracy (P2P file sharing)—copyrighted content is downloaded or shared over the Internet.

Camcorder and Screener piracy are the two main methods in which pirates are able to obtain content for mass replication known as Disc piracy. Screener piracy is the illegal copying of a legitimate advance copy for marketing or screening purposes and most often occurs from within the industry, such as during transport of a legitimate copy from one point to another. Camcorder piracy is the illegal videotaping of a movie from a theatre screen and occurs most often at the premier viewing of new movie releases. Disc piracy is the unauthorized replication of copyrighted content and most often occurs in illegal burn plants facilitated with media pressing technology that can reproduce thousands of copies in less than a day. These forms of piracy are largely performed by professional criminals such as thieves, racketeers and terrorist groups, and are used to generate revenue for personal profit or criminal/terrorist activities.

Internet P2P file sharing is largely performed by industries own consumer bases that use it for personal enjoyment. By understanding this difference between criminals versus consumers, profit versus enjoyment, one can see that Internet P2P file sharing is more of an untapped, undeveloped distribution method costing industry billions in lost revenue each year.

Internet piracy, also known as P2P Internet file sharing is the unauthorized use of copyrighted content over the internet and occurs most often in homes where the consumers are the ones freely sharing the copyrighted content with others. By comparing the people performing piracy and their purposes for performing piracy, the differences between the two main groups and purposes are identified. By understanding these differences, criminal vs consumer, profit vs. enjoyment, one can see that Internet P2P file sharing is an untapped, undeveloped distribution method costing industry billions in lost revenue each year.

In the late nineties, industry began to develop improved methods for coding and handling of copyrighted material. Some of the improvements implemented were changes to the standard format of blank and distribution media, changes to the standard format of copyrighted content, the development of the ISRC—lnternational Standard Recording Code, and increases in burn plant security practices. Since then, other technological solutions have been implemented that are geared towards licensing, digital rights management, content security and performance degradation.

However, these conventional methods and apparatus's have inherent drawbacks that continue to make it difficult to maintain limitations. Most can be removed or disabled via free online removal or disabling tools and no solution implemented as of yet, has provided the ability to identify, distinguish, capture and report the occurring instances of the many different forms of piracy. Given the presence of modem digital technologies, criminals and a consumer base that is openly defiant to the rights of copyright holders and law enforcement agencies, the pirates' and consumers' power to use and redistribute copyrighted content is formidable, ensuring continued losses to industry while increasing funding for terrorists.

It is the inventors' opinion that in order for a piracy solution to be truly effective it must include a system, method and apparatus in which to divide and conquer each individual form of piracy. It must be capable of identifying, locating and stopping as many forms of piracy as possible, thereby aiding governments by negatively affecting the funding of terrorism from piracy. It must be capable of providing the consumer with a strong deterrent that encourages a return to original purchasing traditions, thereby aiding in the slowing of the escalating piracy growth rate. And it must have the capability of creating a feasible method of generating revenue equal to the losses being incurred by the forms of piracy remaining, thereby aiding the funding of job creation and the rebuilding of the industries widely affected by piracy.

Prior art technology such as U.S. Pat. No. 6,601,108 to Marmor, U.S. Patent Application No. 2004/0030599 to Si et al., U.S. Patent Application No. 2002/0026475 to Marmor, U.S. Patent Application No. 2002/0082913 to Li, U.S. Patent Application No. 2004/0148424 to Berkson et al., U.S. Patent Application No. 2003/0012548 to Levy et al., U.S. Patent Application No. 2002/0124251 to Hunter et al., U.S. Patent Application No. 2004/0003398 to Donian et al., and European Patent No. 1,343,318 to Intertrust Technologies, Corp. disclose technology for playing advertisements specifically for use in Motion Picture, Satellite and Broadcast industries content, including a system, method and apparatus to enforce commercial play during instances of satellite and broadcast piracy. Such inventions may use digital rights management, encryption, executable applets, watermarking and intersplicing, for example, but are dependent on externally provided communications.

### BRIEF SUMMARY OF THE INVENTION

In view of the foregoing background, it is therefore an object of the present invention to provide a system, method and apparatus for the detection and capturing of technological crime instances. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The main difference between the present invention and the prior art references mentioned hereinabove is the direction and focus of the inventions. All references mentioned above specifically address one or more forms of piracy with the enforced playing of advertisements. While the present invention also has this capability, the main direction and focal point is in the detection, identifying, capturing, locating and reporting of instances of many different types of technological crimes, not just piracy. Also the inclusion of advertisements is just one of many features of the present invention and does play a role in the detection, identification, capturing, locating and reporting of technological crime instances. I have revised this as this sentence contradicts the next paragraph.

For example, technological crime includes piracy. If the present invention treated all instances of illegal use of copyrighted content equally, where home consumers downloading and true pirates are treated as one, then commercials would not play a role in the overall process of the present invention. The solution, however, does distinguish between the two and commercials play a vital role that assists in the distinguishing between the two. The present invention is not just a crime detection technology, it is also a business model in which industry can successfully meet consumer demands and the industry demands to combat and stop the true mass piracy being performed by criminals.

In particular, the average home user will not have the technical capability to remove commercials mastered into the content or media, and therefore clearly identifies them as consumers. It should be anticipated, however, that at least some, if not most true pirates will have the technical capability to remove the commercials. With the solution to detect piracy utilizing media sub channel properties, content copyright properties and commercial properties, or the lack of a commercial, this then becomes a major and vital role in the identification of pirates versus home consumers.

A primary focus of the present invention is technological crime detection, capturing, locating and reporting specifically for use by Government, Law Enforcement, Child Pornography Associations, Identity Theft Associations, Internet Service Providers, Alliance of Artists and Recording Companies. Also for use in Motion Picture, Recording, Software, Satellite and Broadcast industries content, including a system, method and apparatus to enforce commercial play during instances of disc and internet piracy.

In accordance with the above objects, and those that will be mentioned and will become apparent below, one particular embodiment of the system, method and apparatus, in accordance with this invention comprises an enterprise software application residing on a server, and a software/firmware application residing on one or more hardware chips, on media and in content, including embedding, watermarking, mastering, embedded, burned, programmed or other means, that detects, captures and reports technological crime instances occurring on consumer electronic devices, and is capable of imposing limitations on those technological crime instances and providing location information to authorities.

The present invention also includes a system, method and apparatus to detect, capture, locate and report screener and camcorder piracy, instances of child pornography, online identity theft and spamming. It is noted the present invention, can use hardware, firmware and software embedding, watermarking, mastering, burning, and programming, well known to a person of ordinary skill in the art. It is further noted the present invention's wireless communication architecture is inherent with GPS communications capabilities, as well known in the industry.

In one embodiment, the present invention may include a software/firmware apparatus implemented on a hardware chip, media or within content for enabling a consumer electronic device to detect instances of technological crimes occurring through the use of electronic technology. The predetermined operations including the steps of (a) detecting an instance of a technological crime occurring on the electronic technology, (b) identifying a type of said technological crime instance, and (c) reporting a location of said technological crime instance to at least one interested entity, wherein the interested entity can quickly and efficiently investigate said technological crime instance.

In an alternate embodiment, the present invention includes a customized software application for creating and maintaining the rules, definitions and instructions with which to detect, identify, and report instances of technological crimes. The customized software includes, a server resident enterprise software application consisting of modules that create, maintain and update the software/firmware rules, definitions and instructions to, a remotely located readable medium electronically attached or inserted into an electronic device that detects, captures and reports back instances of technological crime. The readable medium bears software/firmware rules, definitions & instructions detailing the steps of, (a) detecting a technological crime instance occurring on the electronic technology, (b) identifying a type of said technological crime instance, and (c) reporting a location of said technological crime instance to at least one interested entity. The software application further includes various communication protocols for transmitting data between said readable medium and said enterprise software application such that said technological crime instance can be remotely and automatically detected during real-time and thereby enable the interested entity to quickly and efficiently investigate said technological crime instance.

In particular, the enterprise collection center (ECC) is the name of the entire software application and has multiple modules contained within, as shown in FIG. 1. Much like the SAP enterprise application where there are multiple modules contained within, i.e., a suite of financial modules, HR modules, Manufacturing modules, etc . . . (listed hereinbelow). The ECC holds multiple modules as well but these modules are custom specific modules to manage the PIPIR process. The PIPIR process simply put is my algorithm that captures and reports on instances. The ECC is all of the modules required to create, manage and distribute the data received from the PIPIR process: Security Manager—handles all of the security control mechanisms for the PIPIR process; Communications Manager—handles all of the communication control mechanisms for the PIPIR process; Task Manager—this one is the most complex module as this is where the PIPIR process is developed (in the Internal Task Manager module) and produced (in the External Task Manager). When you develop code you develop, test, develop, test . . . (Internal Task Manager tasks), until you reach a stable version that can be released (to the External Task Manager) for version control and quality assurance prior to distribution; Update Manager—handles all of the version control, quality assurance & distribution mechanisms for the PIPIR process. A new version of the PIPIR algorithm is now distributed and data starts to come back.

The following ECC modules are required to manage the data coming back: Instance Manager—handles all of the instance data classification and management mechanisms for the PIPIR process; and Report Manager—handles all of the reporting requirements for the PIPIR process. As with any large system, administrative tasks are also required.

The following ECC modules are required to manage the administrative tasks: Contact Manager—handles all of the client contact information; Device Manager—handles all of the device installation information; and Advertising Manager—handles all of the advertising information.

In one embodiment, the medium may include a communication or internet capable electronic device or a stand alone chip electronically attachable or implemented into an electronic device, for example.

In yet another embodiment of the present invention, a method for detecting, identifying, capturing, locating and reporting instances of technological crimes occurring through the use of consumer electronic technology is disclosed. The method includes the step of: (a) providing an enterprise software application (herein referred to as the enterprise collection center) for creating and managing crime detection rules and definitions and instructions. The enterprise collection center comprising at least one manager module selected from the group including a Security Manager module, a Communications Manager module, an Update Manager module, a Task Manager module, an Instance Manager module, a Report Manager module, a Contact Manager module, a Device Manager module, and an Advertising Manager module.

The Task Manager module preferably includes a development environment herein referred to as the Internal Task Manager and a real time environment herein referred to as the External Task Manager. The method may further include the steps of (b) the Task Manager module receiving datasets from the clients for use in the Internal Task Manager processing; (c) the Internal Task Manager receiving datasets for use in creating, maintaining and managing the detection and capturing the software/firmware rules, definitions and instructions and communicating an updated version of the rules, definitions and instructions to the Update Manager; (d) the Update Manager receiving the updated version for version control and quality assurance testing prior to communicating the updated rules, definitions and instructions to the External Task Manager; (e) the External Task Manager, which may reside on one or more chips in consumer electronic devices, on media or in content, receiving and executing the software/firmware detection rules, definitions and instructions, capturing the instance data and communicating the instance data back to the Enterprise Collection Center; (f the Enterprise Collection Center Instance Manager module receiving the instance data from the External Task Manager and sorting and classifying the instance data; (g) the Enterprise Collection Center Report Manager module reporting and distributing the instance data back to the clients; (h) the rules, definitions and instructions detecting technological crimes including but not limited to child pornography instances, identity theft instances, spamming instances, disc, screener, camcorder and internet piracy instances, satellite and broadcast theft instances; (i) the rules, definitions and instructions identifying technological crimes including but not limited to child pornography instances, identity theft instances, spamming instances, disc, screener, camcorder and internet piracy instances, satellite and broadcast theft instances; (j) the rules, definitions and instructions capturing technological crimes including but not limited to child pornography instances, identity theft instances, spamming instances, disc, screener, camcorder and internet piracy instances, satellite and broadcast theft instances; (k) the rules, definitions and instructions locating technological crimes including but not limited to child pornography instances, identity theft instances, spamming instances, disc, screener, camcorder and internet piracy instances, satellite and broadcast theft instances; (l) the rules, definitions and instructions reporting technological crimes including but not limited to child pornography instances, identity theft instances, spamming instances, disc, screener, camcorder and internet piracy instances, satellite and broadcast theft instances; and (m) viewing or listening of enforced advertisements if disc, screener or internet piracy instances are detected and identified.

It is a further object of the present invention to provide a system, method apparatus to detect, identify, verify, capture, distinguish, report and locate occurrences of technological crime instances for use by government, law enforcement agencies, industries, institutions and associations.

It is a further object of the present invention to overcome one or more of the limitations and disadvantages of the prior art.

It is a further object of the present invention to detect, capture, locate and report instances of technological crime occurrences.

It is another object of the present invention to identify and locate child pornography web servers and detect, capture, locate and report instances of child pornography content viewing.

It is yet another object of the present invention to detect, identify, capture, locate and report consistent patterns of mass emails using various and multiple email identities from the same internet protocol address or network interface communication identifier.

It is another object of the present invention to detect, identify, capture, locate and report consistent patterns of confidential information, such as SSN numbers and credit card numbers over secured or unsecured communications occurring from the same internet protocol address or network interface communication identifier.

It is a further object of the present invention to detect, identify, capture, locate and report instances of disc, screener, internet and camcorder piracy occurrences as they happen.

It is yet another object of the present invention to detect, identify, capture, locate and report instances of disc, screener and internet piracy and enforce the playing of audio or video advertisements.

One feature of the present invention is that when advertisements and this method and apparatus are running on distributed media, content and in chips installed in consumer electronic devices, the present invention functions as a new business model for industries affected by piracy.

Another feature of the present invention is the detection, identification, capturing, reporting and location provisioning capabilities of this system, method and apparatus are an improvement over currently practiced methods, in that they benefit government, law enforcement agencies, industries, associations and the people.

These and other objects, advantages and features of the present invention will become apparent to those skilled in the art from a study of the following Specification when read in conjunction with the attached Drawings and appended Claims.

While this technology is capable of detecting, capturing and reporting of all forms of piracy, it is unrealistic to expect law enforcement agencies to stop chasing the real bad guys and start arresting individual citizens who downloaded a piece of copyrighted content for free from the Internet. Therefore the piracy solution also includes a method in which to turn Internet P2P file sharing into a true distribution method capable of generating revenue by including commercial advertising in copyrighted content. This will be described more in detail in the algorithm detail section.

It is noted the purpose of the foregoing description is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The description is neither intended to define the invention of the application, which is measured by the claims, nor is it intended to be limiting as to the scope of the invention in any way.

### BRIEF DESCRIPTION OF THE VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1, a block diagram illustrating a server based custom software application, herein referred to as the Enterprise Collection Center, comprising manager modules that create, maintain and manage the applications environments, the processes to detect and identify instances of technological crime and the flow of the captured technological crime instance data, according to one embodiment of the invention;

FIG. 1A, a block diagram illustrating the Enterprise Collection Center Task Manager module comprising an Internal Task Manager development environment, and an External Task Manager real time production environment, according to one embodiment of the invention;

FIG. 1B, a block diagram illustrating a two way flow of information to and from the Enterprise Collection Center, the External Task Manager and the Government, Industries, Law Enforcement Agencies, Industries, Institutions and Associations, herein referred to as the clients, according to one embodiment of the invention;

FIG. 1C, a block diagram illustrating an install base for the External Task Manager and the methods and means of communications utilized to communicate with the Enterprise Collection Center, according to one embodiment of the invention;

FIG. 1D, a block diagram illustrating a processing flow of the client provided information, herein referred to as datasets, through the Enterprise Collection Center Manager modules and reported back to the clients, according to one embodiment of the invention;

FIG. 1E, a block diagram illustrating a processing flow of datasets through the Enterprise Collection Center Manager module applications and reported back to the clients, according to one embodiment of the invention;

FIG. 1F, a block diagram illustrating an Enterprise Collection Center Contact Manager process for setup and receiving of client contact information and first time datasets, according to one embodiment of the invention;

FIG. 1G, a block diagram illustrating an Enterprise Collection Center Task Manager process for receiving and processing of additional datasets by the Internal Task Manager, according to one embodiment of the invention;

FIG. 1H, a block diagram illustrating a processing flow of datasets through the Enterprise Collection Center modules and Internal Task Manager and External Task Manager applications environments for use in the detection, identification, verification, capture, classification and reporting back to the clients, according to one embodiment of the invention;

FIG. 1J, a block diagram illustrating a processing flow of datasets through the Enterprise Collection Center Internal Task Manager environment to the External Task Manager environment, according to one embodiment of the invention;

FIG. 1K, a block diagram illustrating an Enterprise Collection Center Update Manager process for version control and quality assurance testing of Internal Task Manager updated versions of the rules and definitions for communication to and use by the External Task Manager, according to one embodiment of the invention;

FIG. 2, a flow diagram illustrating an External Task Manager software/firmware instruction operation in response to technological crime occurrence instances, according to one embodiment of the invention;

FIG. 2A, a flow diagram illustrating an External Task Manager software/firmware instruction operation in response to unauthorized access or tampering instances, according to one embodiment of the invention;

FIG. 2B, a flow diagram illustrating an External Task Manager software/firmware instruction operation in response to piracy instances, according to one embodiment of the invention;

FIG. 3, a block diagram illustrating a processing flow of instance data captured from the External Task manager for processing by the Instance Manager, according to one embodiment of the invention;

FIG. 3A, a block diagram illustrating a processing flow of processed instance data for use in the Report Manager notifications and report generation, according to one embodiment of the invention;

FIG. 3B, a flow diagram illustrating an Instance Manager data classification and Report Manager notification and reporting process, according to one embodiment of the invention;

FIG. 4, a block diagram illustrating a process for placement and inclusion of the External Task Manager on chips for use in consumer electronic devices, according to one embodiment of the invention;

FIG. 4A, a block diagram illustrating a process for placement and inclusion of the External Task Manager on media and in content, according to one embodiment of the invention;

FIG. 4B, a block diagram illustrating a method and means of the Enterprise Collection Center communicating to the External Task Manager, according to one embodiment of the invention;

FIG. 4C, a block diagram illustrating a method and means of the External Task Manager communicating to the Enterprise Collection Center, according to one embodiment of the invention;

FIG. 5, a block diagram illustrating a processing flow of datasets through the Device Manager module, according to one embodiment of the invention;

FIG. 5A, a block diagram illustrating a processing flow of datasets through the Advertising Manager module, according to one embodiment of the invention;

FIG. 5B, a block diagram illustrating a processing flow of incoming transmissions through the Security Manager and the Communications Manager modules, according to one embodiment of the invention; and

FIG. 6 is a block diagram illustrating the major components of the ECC and the communication link between such major components.

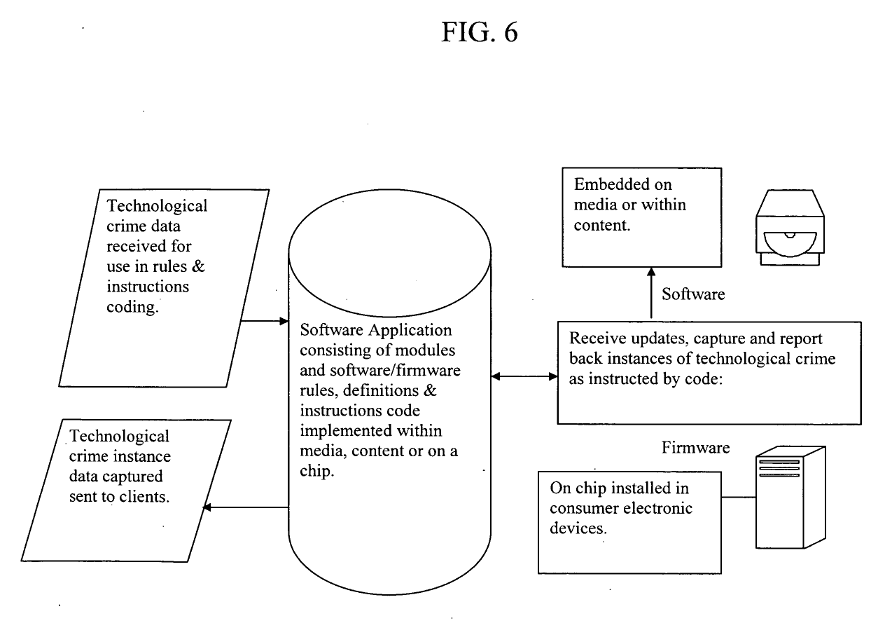

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

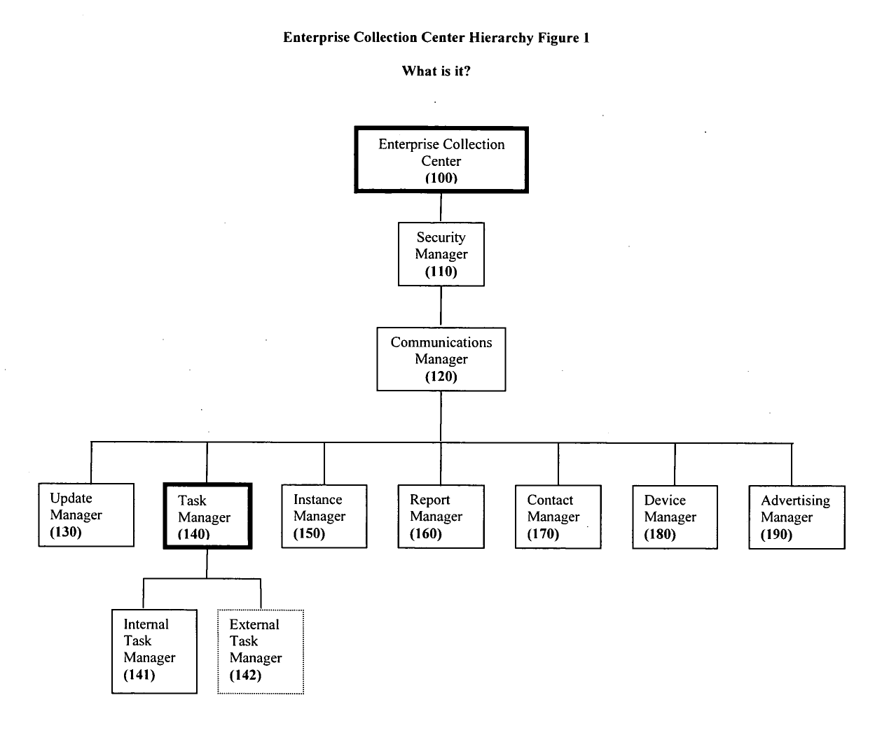

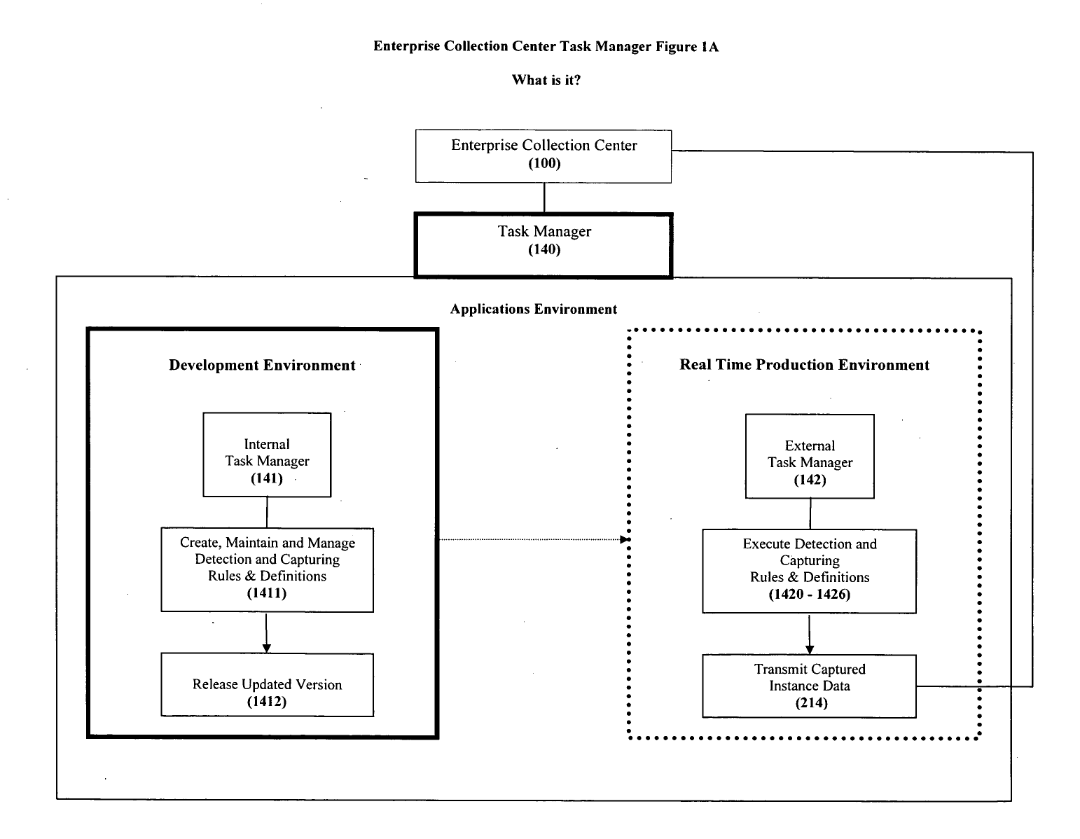

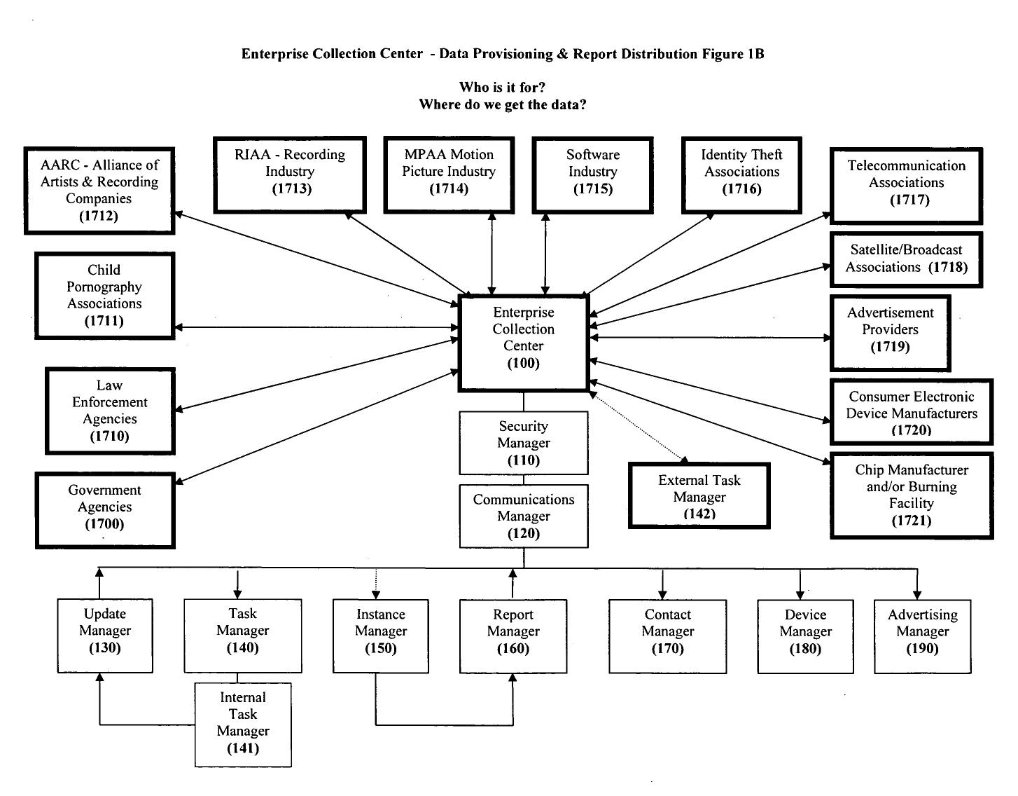

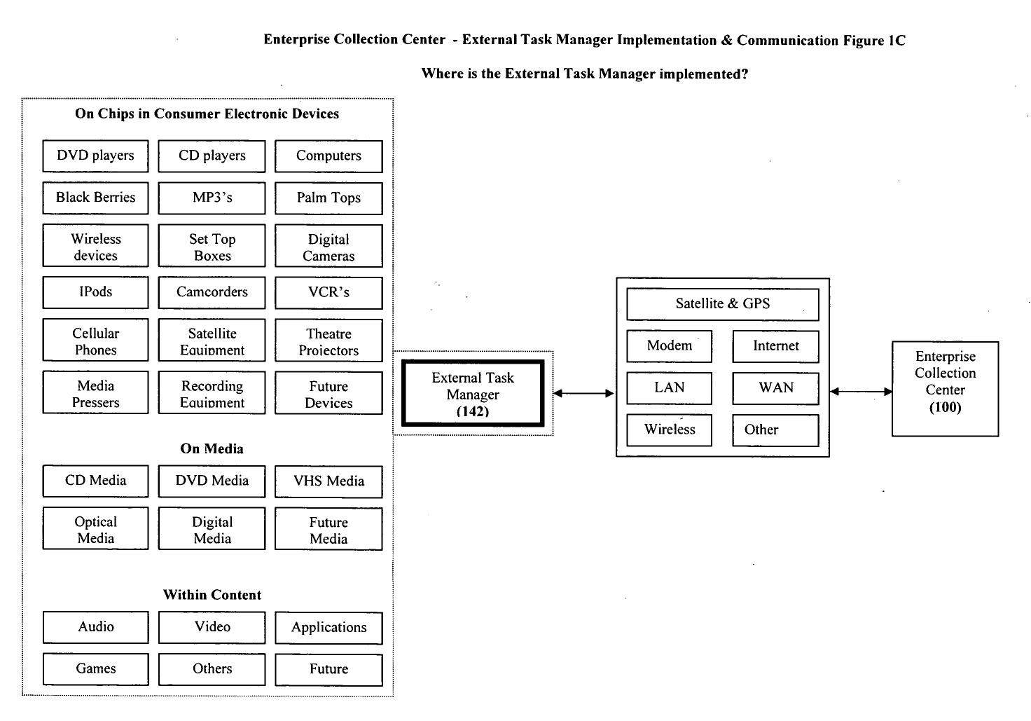

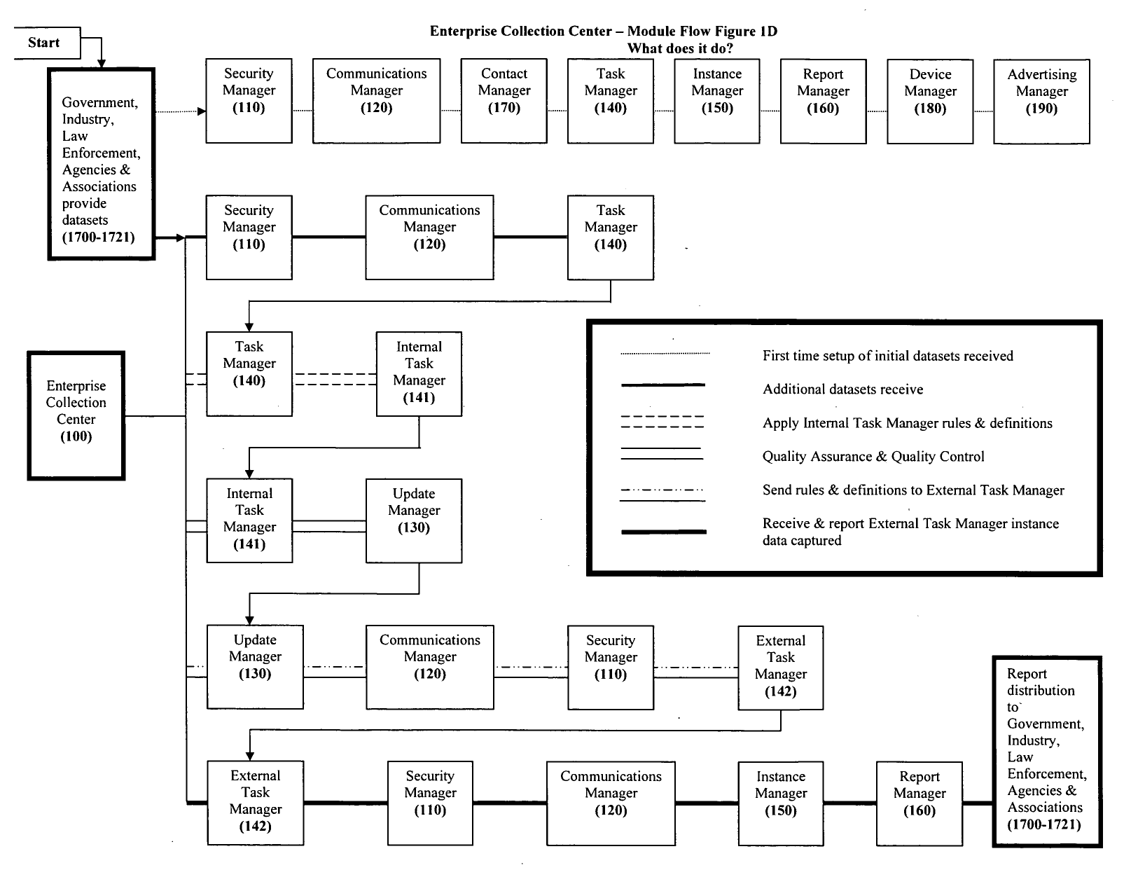

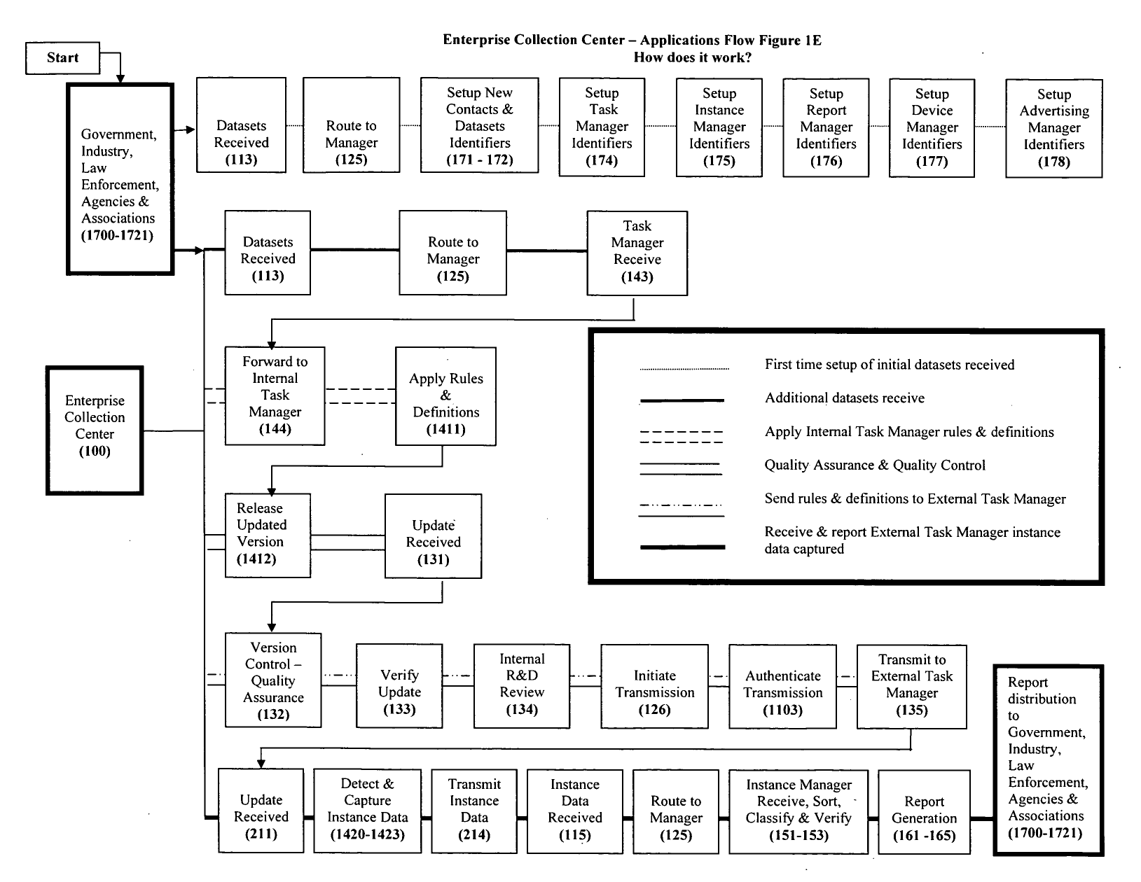

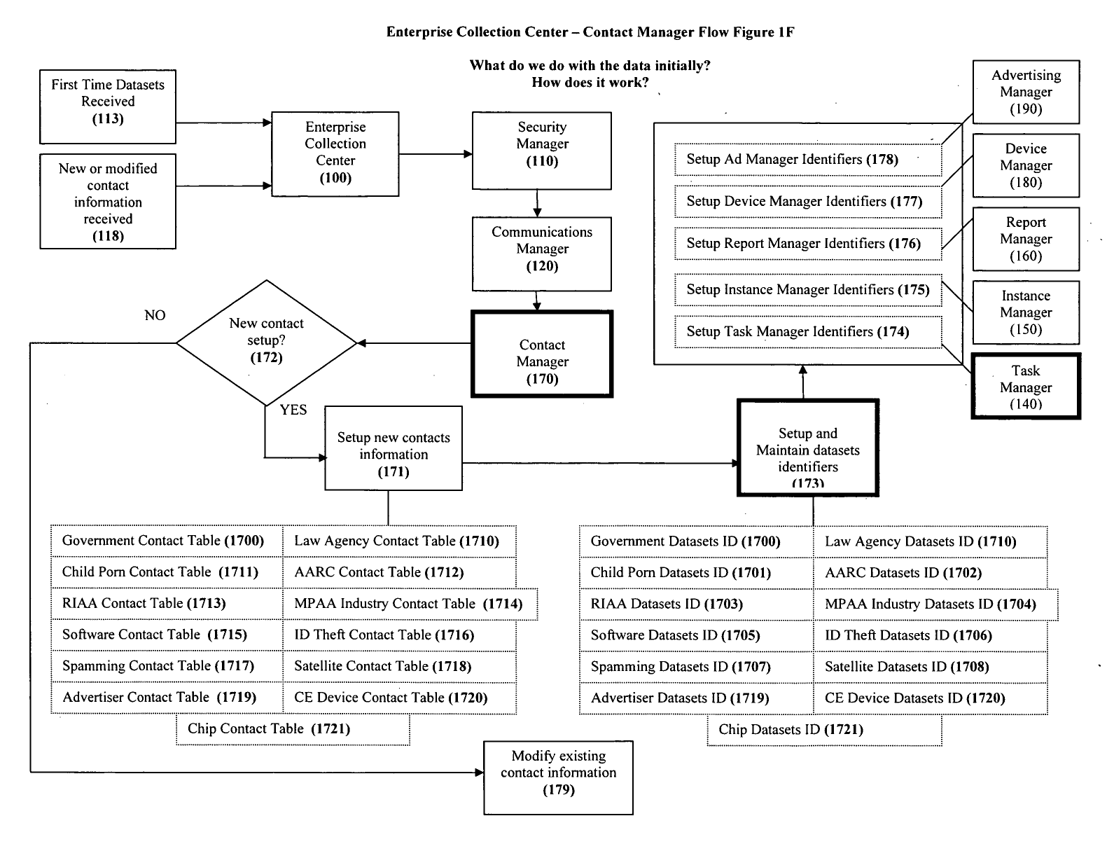

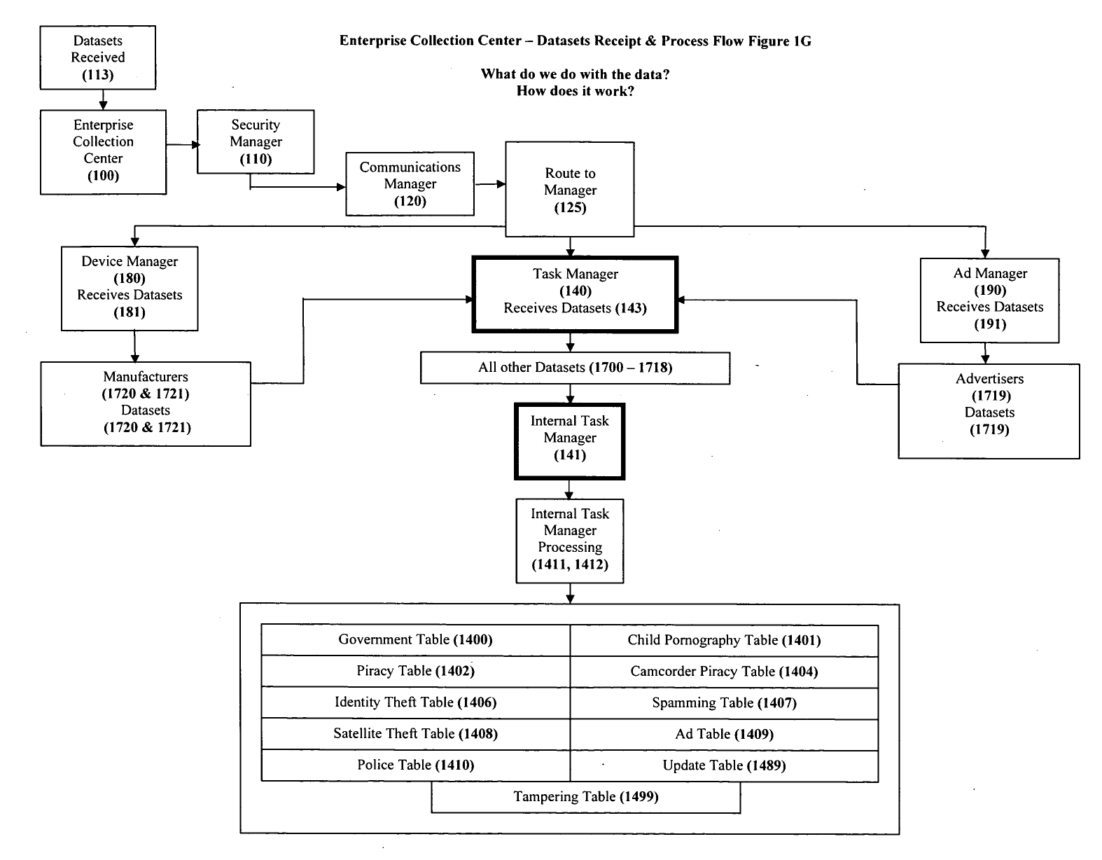

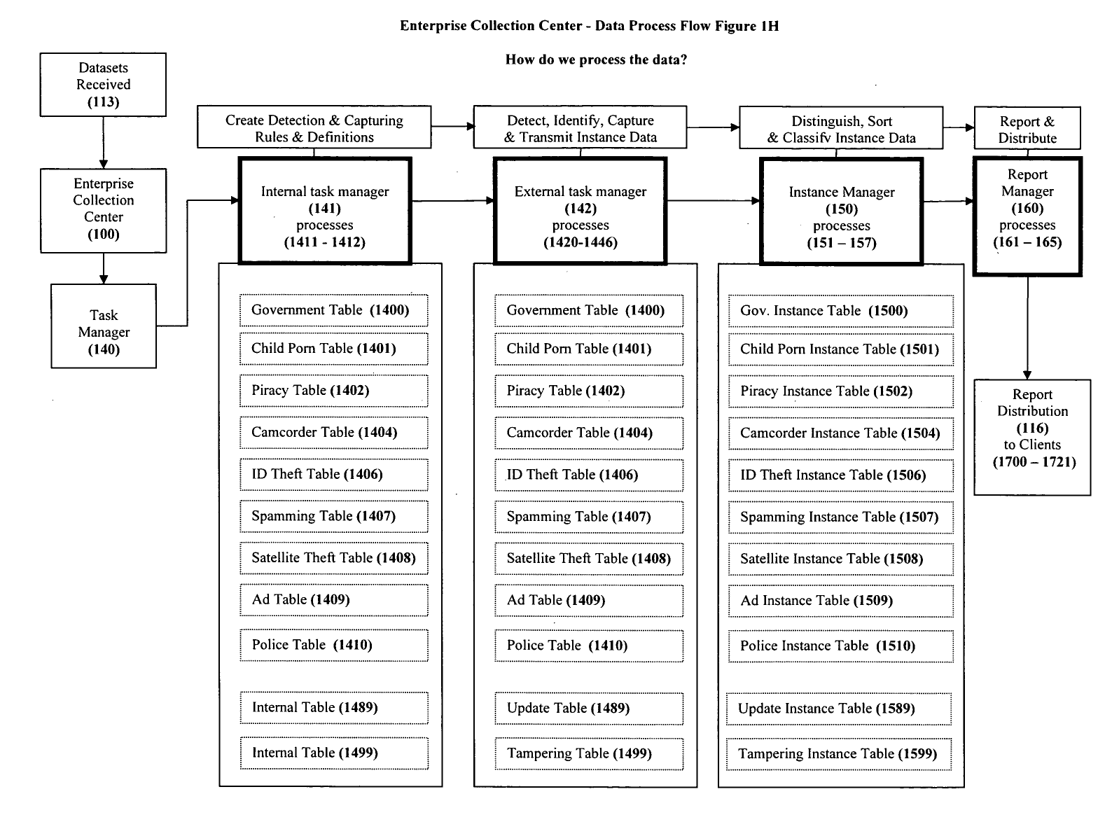

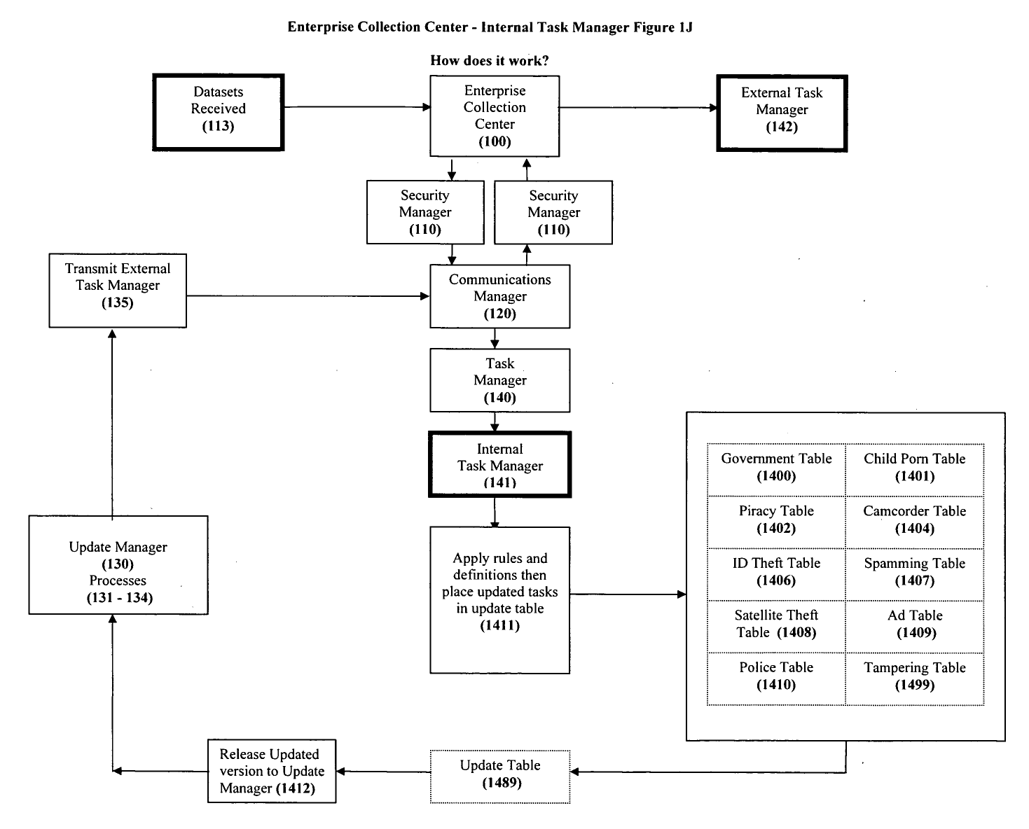

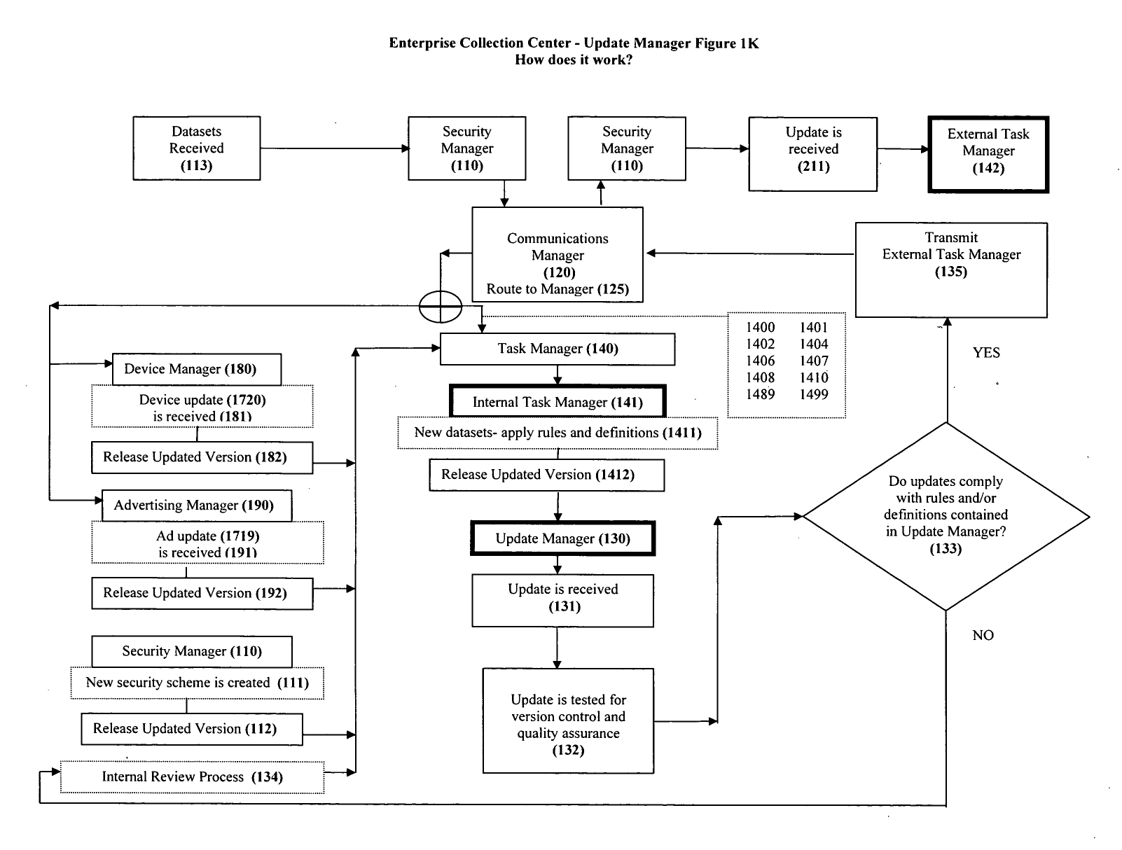

The apparatus of this invention is referred to generally in FIGS. 1-5 and is generally referred to as PIPIR technology. It should be understood that the present invention may be used to detect, identify, capture and locate various types of technological crimes listed hereinabove, for example. Therefore, the present invention should not be construed as limited to detecting, identifying, capturing and locating any one particular technological crime.

PIPIR technology is simply put a crime detection technology capable of detecting, capturing and reporting instances of crimes that occur through the use of technology, including but not limited to piracy and child pornography. PIPIR Technology uses the following components to detect, capture and report illicit uses occurring on consumer electronic technology:
Algorithms—one for each illicit use by medium
   BlackFin Chipset Series Chip
   Enterprise Collection Center

There are now newer cheaper Blackfin chips which are capable of performing the required functions. I think it best to not limit ourselves to any one particular Blackfin chip. This has just recently occurred. Remove this paragraph completely.

The software/firmware algorithms and the Enterprise Collection Center are designed and created by the inventor for use on the BlackFin Chipset Series, created and manufactured by Intel & Analog Devices. This series of chips use Micro Signal Architecture, Digital Signal Processing, Power Management and are GPS capable.

The main functionality of the software/firmware algorithms programmed onto the Blackfin chips all share one commonality, they are structured to detect, identify, capture and report instances of criminal/illicit activity occurring on consumer electronic devices, including but not limited to child pornography, spamming and piracy, for example. When the chip has detected and captured data, the data is then transmitted through Satellite, Internet and/or GPS, for example, to the Enterprise Collection Center application. The Enterprise Collection Center application then analyzes the data received, splits the data into a specific class and triggers an alert for suspect data to be investigated by authorities or other authorized persons/groups of interest.

Referring first to FIG. 1, a block diagram is shown of an embodiment of a custom software application hierarchy structure, the Enterprise Collection Center 100. The Enterprise Collection Center 100 is the central hub for the creation and management of the software/firmware crime detection rules and definitions and for the receiving of the instance data and for classification and reporting. The Enterprise Collection Center 100 comprises modules herein referred to as, Security Manager 110, Communications Manager 120, Update Manager 130, Task Manager 140, Instance Manager 150, Report Manager 160, Contact Manager 170, Device Manager 180, and Advertising Manager 190. The Task Manager 140 comprises an Internal Task Manager 141 and an External Task Manager 142.

With reference to FIG. 1A, a block diagram is shown of an embodiment of the Enterprise Collection Center 100 Task Manager 140 applications environment. The Task Manager 140 applications environments comprise an Internal Task Manager 141 development environment, and an External Task Manager 142 real time production environment.

The Internal Task Manager 141 creates, maintains and manages the software/firmware instructions rules and definitions 1411 for detecting and capturing technological crime instances, and releases updated versions 1412 for use solely by the External Task Manager 142. The External Task Manager 142 executes the software/firmware detection and capturing rules, definitions and instructions 1420-1426, and transmits the captured instance data 214 back to the Enterprise Collection Center 100. The Internal Task Manager 141 and the External Task Manager 142 are further described and will become more apparent in the ensuing figures.

Referring now to FIG. 1B, a block diagram is shown of an embodiment of the Enterprise Collection Center 100 Security Manager 110, and the Communications Manager 120, maintaining two way communications between the Enterprise Collection Center 100 and the External Task Manager 142 and two way communications between the Enterprise Collection Center and; Government Agencies 1700, Law Enforcement Agencies 1710, Child Pornography Associations 1711, AARC—Alliance of Artists and Recording Companies 1712, RIAA—Recording Industry Association of America 1713, MPAA—Motion Picture Association of America 1714, Software Industry 1715, Identity Theft Associations 1716, Telecommunications Associations 1717, Satellite & Broadcast Associations 1718, Advertisement Providers 1719, Consumer Electronic Device Manufacturers 1720, And Chip Manufacturers & Burn Facilities 1721, herein referred to as the Clients 1700-1721.

Referring next to FIG. 1C, a block diagram that shows an embodiment of the various methods in which the External Task Manager 142 can be implemented including but not limited to, on one or more chips for installation in consumer electronic devices, on media or within content. Also shown are the various form(s) of communications the External Task Manager 142 uses to communicate with the Enterprise Collection Center 100, based on how and where the External Task Manager 142 is implemented. Communications forms include satellite, GPS, modem, internet, peer to peer, LAN, WAN, wireless and other conventional means of communications well known in the industry.

Referring now to FIG. 1D, a block diagram shows an embodiment of the Enterprise Collection Center 100, modular flow upon receiving datasets from the clients 1700-1721. In one embodiment the clients 1700-1721 provide initial datasets for first time setup in the Enterprise Collection Center 100 Manager Modules 110, 120, 140-190. Initial datasets are received from the clients 1700-1721 via the Security Manager 110 and the Communications Manager 120 for first time setup by the Contact Manager 170. The Contact Manager 170 then completes first time setup processing for datasets uses in the Task Manager 140, Instance Manager 150, Report Manager 160, Device Manager 180 and the Advertising Manager 190. First time setup of datasets is further described in detail and will become more apparent in FIG. 1F.

In another embodiment, clients 1700-1721 provide additional datasets for processing through the Enterprise Collection Center 100 for use in the technological crime instance detection software/firmware instruction rules and definitions. Datasets are received via the Security Manager 110 and the Communications Manager 120 for use by the Task Manager 140 Internal Task Manager 141. The Internal Task Manager 141 manages and maintains all software/firmware instruction rules and definitions for the detection and capturing of technological crime instances and applies said software/firmware instruction rules and definitions to the datasets received from the clients 1700-1721. Updated software/firmware instruction rules and definitions are then processed by the Update Manager 130 and transmitted via the Communications Manager 120 and the Security Manager 110 to the External Task Manager 142. The External Task Manager 142 executes the software/firmware instruction detection rules and definitions and captures the technological crime instance data for transmission to the Enterprise Collection Center 100 via the Security Manager 110 and the Communications Manager 120. Instance data is received and processed at the Instance Manager 150 prior to the Report Manager 160 report generation processing and distribution to the clients 1700-1721. Datasets processing is further described in more detail and will become more apparent in FIG. 1G.

It should be stated at this time that FIG. 1D and FIG. 1E are two variations of the same diagram. FIG. 1D shows the data processing flow by Manager Modules 110-190, whereas FIG. 1E shows the data processing flow by applications resident within each of the Manager Modules 110-190. For example noted below is a comparison of the additional datasets received on FIG. 1D and FIG. 1E. The Security Manager 110 in FIG. 1D receives the datasets 113 in FIG. 1E. The Communications Manager 120 in FIG. 1D, then routes the datasets 125 in FIG. 1E, to the Task Manager 140 in FIG. 1D, for receiving 143 and forwarding 144 of the datasets, in FIG. 1E, to the Internal Task Manager 141 in FIG. 1D.

With reference to FIG. 1E, a block diagram depicting an embodiment of the Enterprise Collection Center 100 module applications flow upon receiving datasets from the clients 1700-1721. In one embodiment the clients 1700-1721 provide initial sets of data for first time setup in the Enterprise Collection Center 100 Manager Modules 110, 120, 140-190. Initial datasets are received 113, any new contact information is then setup 171, contact datasets identifiers are assigned 172, Task Manager identifiers are setup 174, Instance Manager identifiers are setup 175, Report Manager identifiers are setup 176, Device Manager identifiers are setup 177 and Advertising Manager identifiers are setup 178. First time setup of datasets is further described in detail and will become more apparent in FIG. 1F.

In another embodiment the clients 1700-1721 provide additional datasets for processing through the Manager Modules 110-190 for use in the technological crime instance detection software/firmware instruction rules and definitions. Datasets are received 113 and routed 125 to the appropriate Manager Module 110, 120, 140-190. The routing of the datasets to the appropriate Manager Module 110, 120, 140-190 is further described and will become more apparent in FIG. 1G.

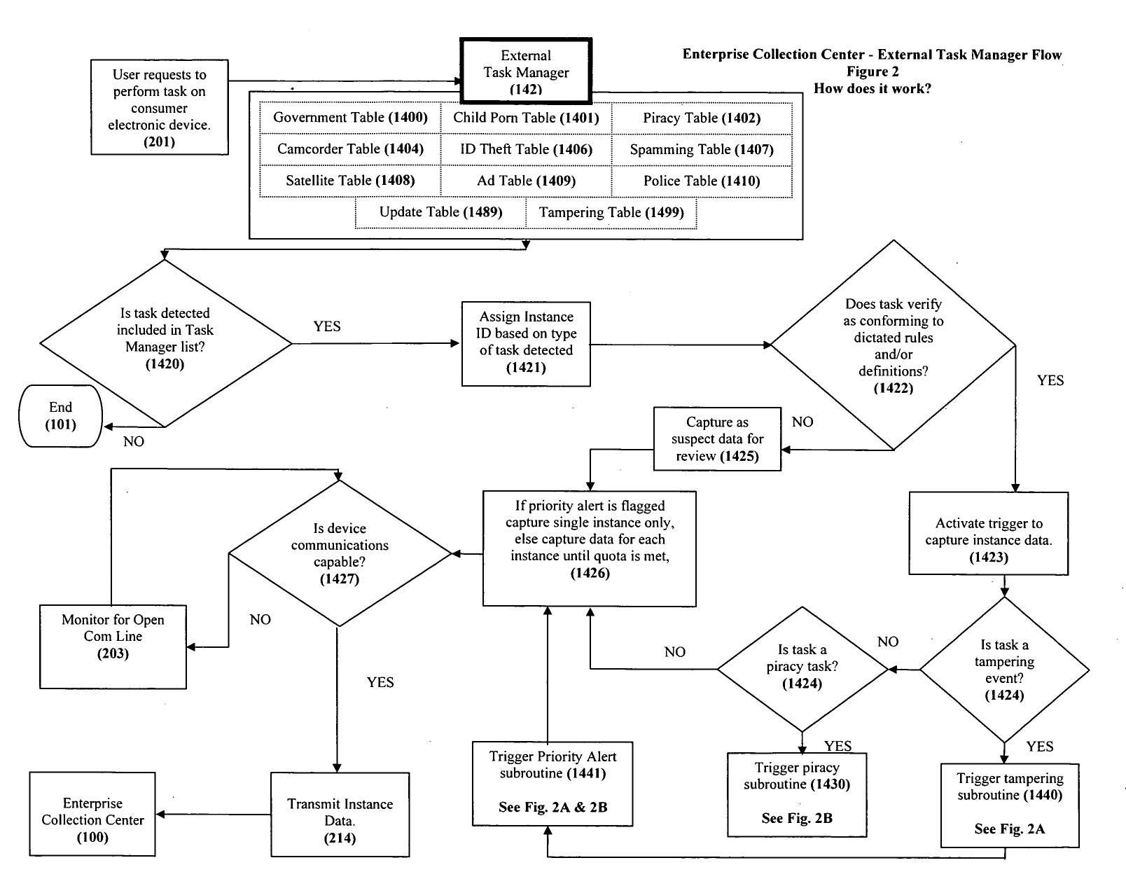

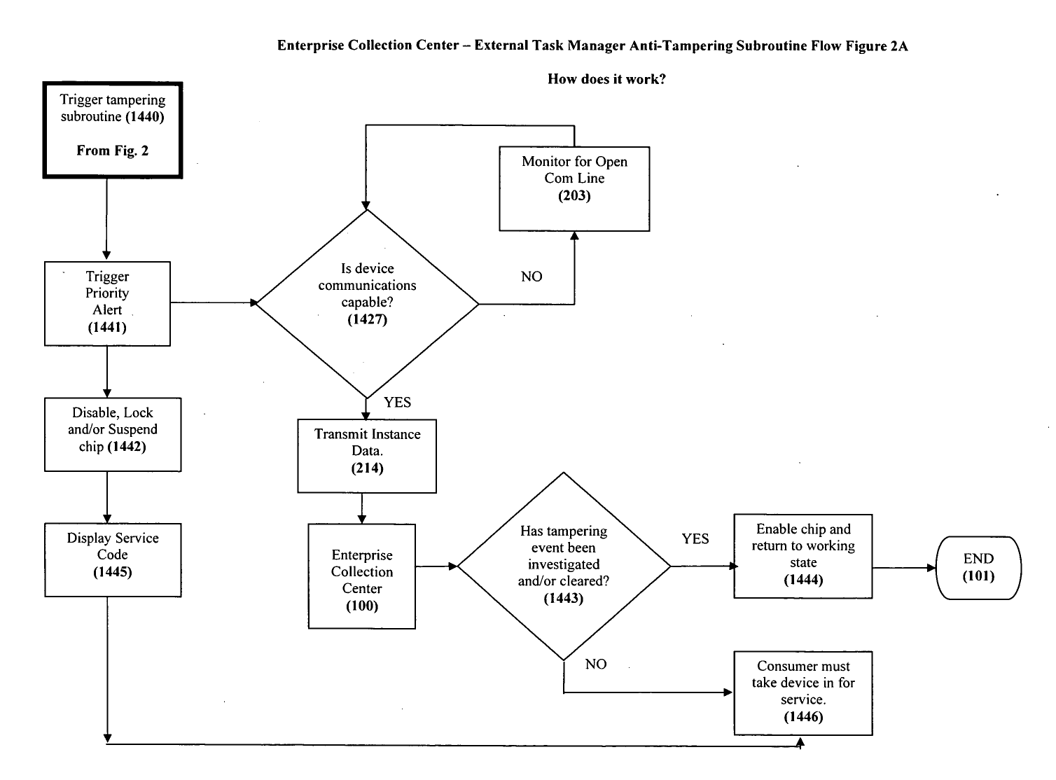

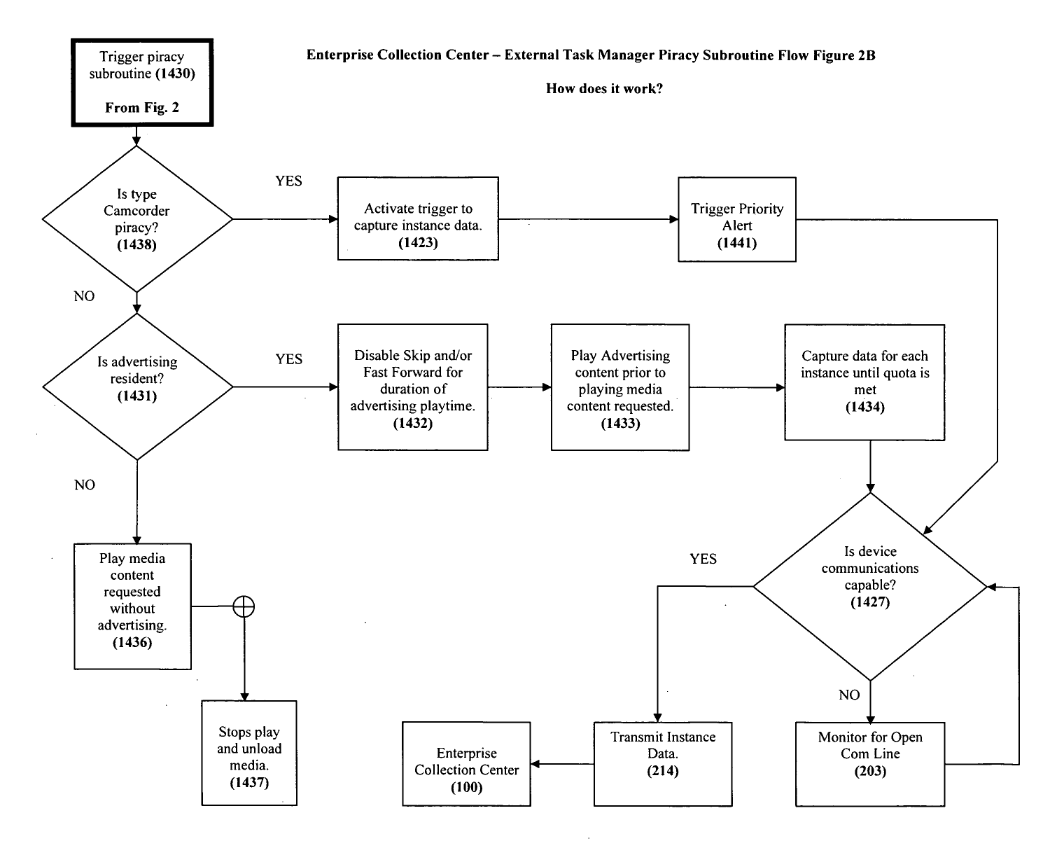

Datasets are ultimately received 143 by the Task Manager 140 and forwarded for receipt 144 by the Internal Task Manager 141 for processing and use in the detection scheme software/firmware instruction rules and definitions 1411. Detection scheme software/firmware instruction rules and definitions are created, revised and/or applied 1411 resulting in the release of an updated version 1412 which is then received 131 by the Update Manager 130. The Update Manager 130 processes and tests updated versions 1412 for version control and quality assurance 132, then verifies and confirms 133 the updated version 1412 is complete. Updated versions 1412 that do not pass the verification and confirmation process 133, are then flagged for internal review 134 and are not transmitted. Updated versions 1412 that are verified and confirmed 133 are then transmitted 135 to the External Task Manager 142. Transmitted updates 135 are received 211 by the External Task Manager 142 and used in the detection and capturing 1420-1423 of technological crime instances, as further described and will become more apparent in FIG. 2. The External Task Manager 142 detects and captures 1420-1423 instances of technological crimes occurring, transmits 214 instance data captured back to the Enterprise Collection Center 100 Instance Manager 150. Instance data is received, classified and processed 151-153, by the Instance Manager 150 prior to the Report Manager 160 generating and distributing 161-165 the reports to the clients 1700-1721, as previously described in FIG. 1B.

The External Task Manager 142 continues using the updated version 1412 until a new version is received. The External Task Manager 142 cyclically repeats the process of detecting and capturing 1420-1423 instances of technological crimes occurring, then transmits captured instance data 214 to the Enterprise Collection Center 100 Instance Manager 150, for processing and reporting to the clients 1700-1721.

Referring next to FIG. 1F, a flow diagram illustrating an embodiment of a Contact Manager 170 process for the first time setup 171 of the clients 1700-1721, and datasets and/or for modification 179 of existing contact information. In one embodiment the Contact Manager 170 manages the setup of new clients 171 and their datasets 173 in the Enterprise Collection Center 100. For each new client 171 providing datasets 173, the Contact Manager 170 assigns an associated and unique datasets identifier 174-178 in the Task Manager 140, the Instance Manager 150, the Report Manager 160, the Device Manager 170, and the Advertising Manager 190. This associated and unique datasets identifier structure 173-178 affords ease in managing, tracking and reporting for the numerous datasets to be contained and utilized within the Enterprise Collection Center 100. This datasets identifier structure 173-178 is further described and will become more apparent in FIG. 1H.

In another embodiment, the Contact Manager 170 manages and maintains existing client contact information 1700-1721, for modifying, adding, changing and deleting 179.

Referring now to FIG. 1G, a block diagram illustrates an embodiment of a process for the receiving of additional datasets 113 from existing clients 1700-1721. Datasets are received 113 at the Enterprise Collection Center 100 via the Security Manager 110 and the Communications Manager 120, which then routes the datasets to the appropriate Manager 125.

Datasets 1720 & 1721 received 113 from consumer electronic device manufacturers 1720 and chip manufacturing and production facilities 1721 are routed 125 first to the Device Manager 180 for storing and processing. Datasets 1719 received 113 from advertisers 1719 are routed 125 first to the Advertising Manager 190 for storing and processing. Key information from those datasets 1720, 1721 & 1719 are then sent to the Task Manager 140 for use in the Internal Task Manager 141 processes 1411-1412.

Datasets received 113 from all other clients 1700-1718, are routed 125 directly to the Task Manager 140 for use in the Internal Task Manager 141 processes 1411-1412. Internal Task Manager 141 processing 1411-1412 is further described in detail and will become more apparent in FIG. 1J.

Referring next to FIG. 1H, a block diagram illustrates a data and application process flow through the Enterprise Collection Center 100 to the Task Manager 140 for utilization in the Internal Task Manager 141 processing 1411-1412. In one embodiment, the Internal Task Manager 141 receives the datasets 113 and processes 1411 the datasets for use in creation, modification and application of the detection and capturing a software/firmware instruction rules and definitions. The Internal Task Manager 141 updated version 1412 of the software/firmware instruction rules and definitions are then transmitted to the External Task Manager 142 for use in the detection, capturing and reporting 1420-1446 of technological crime instance data. Occurrence instances are detected and captured by the External Task Manager 142 processes 1420-1446 and sent to the Enterprise Collection Center 100 Instance Manager 150 for sorting and classification processing 151-157. Once the Instance Manager 150 processing 151-157 is complete, the Report Manager 160 processes are performed, providing notifications and report generation and distribution 161-165 to the clients 1700-1721.

In another embodiment, the datasets identifiers are used to track and manage the multiple datasets through the Enterprise Collection Center 100 modules 140-160 application process flows 1411-1412, 1420-1446, 151-157 & 161-165. At any one time, the data provided by the clients 1700-1721 and the instance data being captured and reported from the External Task Manager 142, can be traced and located within the Enterprise Collection Center 100. Tracking and traceability of the data at each point in the process is paramount. As critical crime datasets are provided, the datasets identifiers allow ease in following and tracking the data through the Manager Modules 110-190, as previously described in FIG. 1, comprising the Enterprise Collection Center 100. Thereby ensuring the timely update of critical information to the External Task Manager 142, and time sensitive reporting back to the clients 1700-1721.

With reference now to FIG. 1J, a block diagram illustrating a Task Managers 140 Internal Task Manager 141 process flow to create, manage and apply the software/firmware instruction rules and definitions 1411-1412 used by the Task Managers 140 External Task Manager 142 to detect and capture instances of technological crimes. In one embodiment, datasets are received 113 via the Security Manager 110 and the Communications Manager 120 and routed to the Task Manager 140 for use by the Internal Task Manager 141. The Internal Task Manager 141 creates, manages and applies the software/firmware instruction rules and definitions 1411 against key table information 1400-1499 from each of the datasets received, such as known child pornography web-site addresses. The Internal Task Manager 141 then releases an updated version 1412 of the software/firmware instruction rules and definitions 1412 to the Update Manager 130 for quality assurance/quality control testing 131-134 prior to transmitting the updated version 1412 to the External Task Manager 142. The Update Manager 130 and its relationship with the Internal Task Manager 141 and the External Task Manager 142 are further described and will become more apparent in FIG. 1K.

Referring next to FIG. 1K, a flow diagram illustrates the process flow and function of the Update Manager 130. In one embodiment, datasets are received 113 at the Enterprise Collection Center 100 via the Security Manager 110 and the Communications Manager 120 and routed to the Task Manager 140 for use by the Internal Task Manager 141. As mentioned in FIG. 1G, datasets received from the consumer electronic device manufacturers 1720 and chip manufacturers and production facilities 1721 are received at the Device Manager 180 and datasets from advertisers 1719 are received at the Advertising Manager 190. All other client datasets 1400-1402, 1404, 1406-1408 & 1410 are received at the Task Manager 140, for use in Internal Task Manager 141 processing 1411-1412.

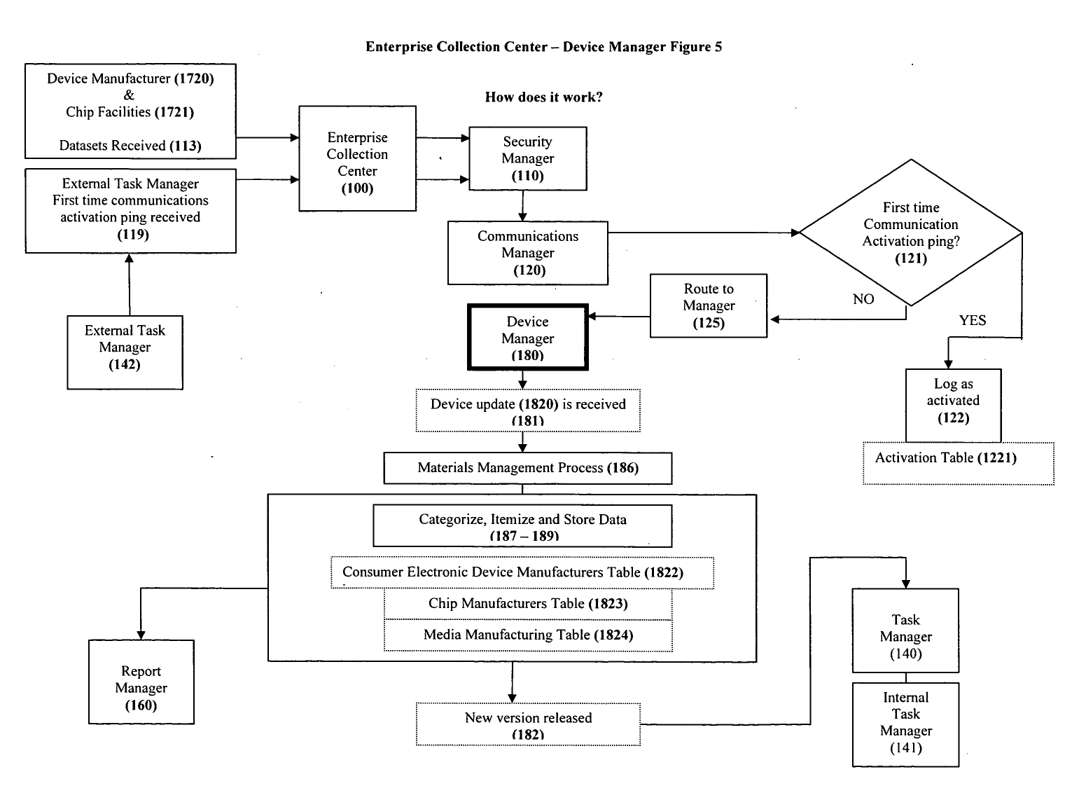

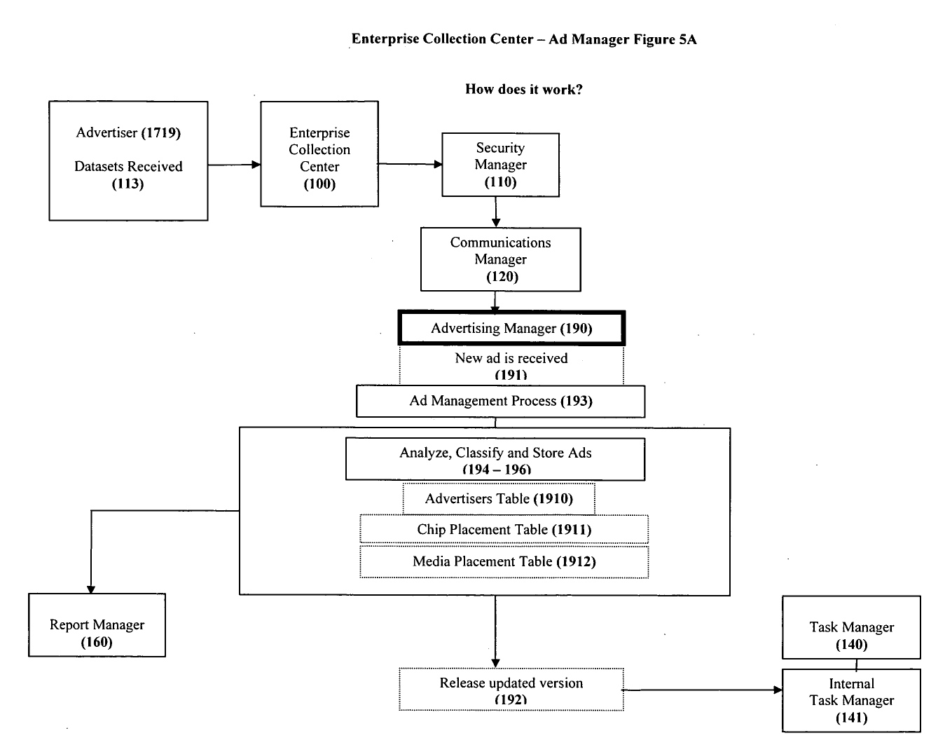

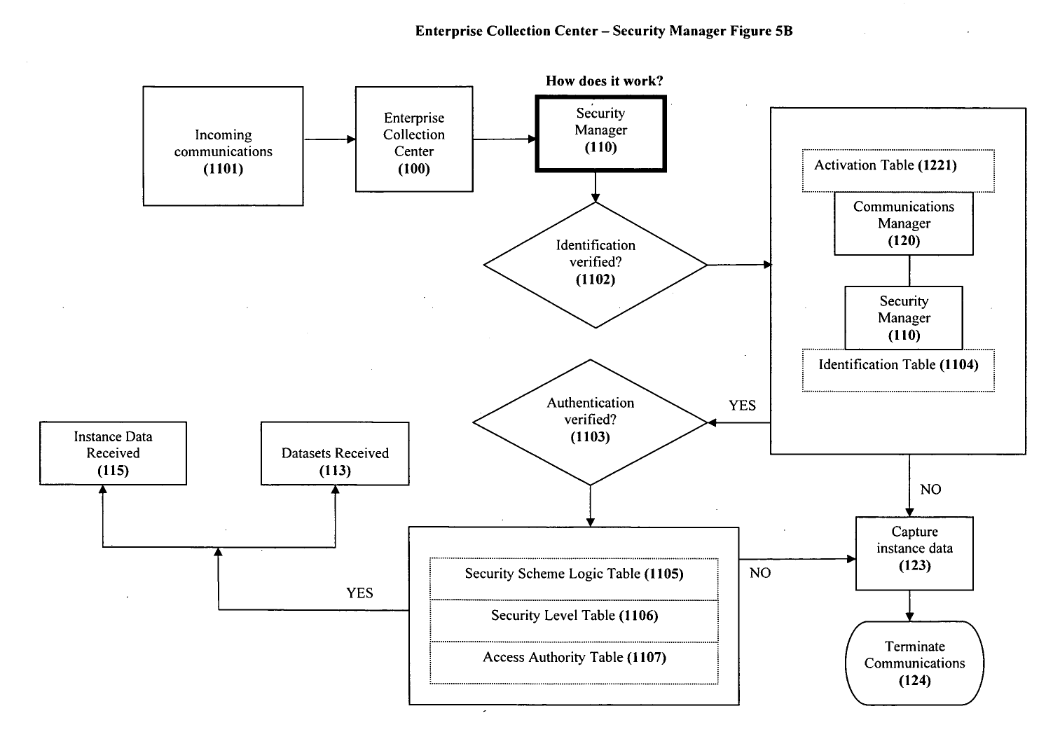

The Device Manager 180 and the datasets received 113 at the Device Manager 180 are further described and will become more apparent in FIG. 5. The Advertising Manager 190 and the datasets received 113 at the Advertising Manager 190 are further described and will become more apparent in FIG. 5A.

In one embodiment, the Internal Task Manager 141 releases an updated version 1412 to the Update Manager 130 for version control and quality assurance processing and testing 132, followed by update compliance verification 133 and transmittal of the update 114 to the External Task Manager 142. In the event that the update does not meet the update compliance verification 133 process, the update is flagged for internal review 134 and is not transmitted.

Referring next to FIG. 2, a flow diagram illustrating an External Task Manager 142 detection 1420 capturing 1423 and reporting 214 process. In one embodiment, a user request 201 is made, such as accessing a known child pornography web-site or a load event is occurring with media that contains copyrighted content. The External Task Manager 142 detects each instance 1420, assigns a unique identifier 1421, performs a second check verification process 1422 prior to capturing instance data 1423 and if verification of the instance is received, captures the instance data 1423 for the technological crime occurring.

It should be mentioned at this time that the two level detection 1420 and verification 1422 process has been implemented for the privacy and security of confidential information and for the purpose of identifying new methods and ways in which to detect how technological crimes are being performed. In the event that the task does not receive second level verification 1422, specific data is captured 1425 relating to the method in which the event occurred, causing it to trigger the first level detection event 1420.

Once instance data has been captured 1423, third level classification is performed 1424 to determine the type of technological crime being captured. In the event that the task being performed is a tampering event 1424, the anti-tampering subroutine 1440 is triggered which is described in further detail and will become more apparent in FIG. 2A. In the event that the task being performed is a piracy event 1424, the piracy subroutine 1430 is triggered which is described in further detail and will become more apparent in FIG. 2B. All technological crime occurrences could be structured to cause additional subroutines to be triggered, such as priority alert 1441 notifications.

Once the pre-determined quota of instances has been captured 1426 or storage capacity has been reached, verification of communications is performed 1427 and the captured instance data 1426 is transmitted 214 to the Enterprise Collection Center 100. In the event that communications are not verified 1427, the External Task Manager 142 monitors for open communications 203 and once verified 1427 transmits 214 the captured instance data 1426 to the Enterprise Collection Center 100. The External Task Manager 142 continuously repeats the cycle of detecting 1420, capturing 1423 and transmitting 214 instances of technological crimes to the Enterprise Collection Center 100 for use in reporting to the clients 1700-1721.

The verification of communications is performed in the event that the External Task Manager 142 implemented on media and in content is being utilized on a standalone device. Also in the event that the External Task Manager 142 installed on one or more chips is unable to communicate via GPS and satellite, such as in the case of a down satellite link, instance data captured 1426 is not lost.

Referring next to FIG. 2A, a flow diagram illustrates an External Task Manager 142 anti-tampering process 1440, as depicted in FIG. 2. In one embodiment the External Task Manager 142 detects, verifies and captures an instance of tampering, such as an unauthorized access and triggers the tampering subroutine 1440. First a priority alert is triggered 1441, flagging the data as priority data, then verification of communications is performed 1427 and the instance data is transmitted 214 to the Enterprise Collection Center 100. In the event that communications are not verified 1427, the External Task Manager 142 monitors for open communications 203 and once verified 1427 transmits 214 the instance data to the Enterprise Collection Center 100. The power management features of the chip are used to disable, lock or suspend 1442 the device and a service code is displayed on the device 1445, forcing the consumer to take the device in for servicing 1446.

The Enterprise Collection Center 100 staff reviews the priority instance data received 214. In the event that the tampering instance can be investigated 1443 and cleared by Enterprise Collection Center 100 staff, a remote signal can be sent re-enabling 1444 power to the device.

It should be mentioned at this time, that External Task Managers 142 implemented on media and in content, at present day, are expected and anticipated to have certain limitations with respect to communications and power management capabilities. The External Task Manager 142 implemented on media and in content may be reliant on the playing device in which it is being utilized on to transmit instance data and priority data to the Enterprise Collection Center 100. Power Management capabilities of the External Task Manager 142 implemented on media and in content may also be limited in the same manner. These media and content based limitations however, do not exist for the External Task Manager 142 implemented on one or more chips installed in consumer electronic devices, as the chips have full GPS communications and power management capabilities.

Referring now to FIG. 2B, a flow diagram illustrates an External Task Manager 142 piracy process, as depicted in FIG. 2. In one embodiment the External Task Manager 142 detects, verifies and captures an instance of piracy and determines if the piracy type is camcorder piracy 1438. If the piracy type being performed is camcorder piracy 1438, the instance data is captured 1423, a priority alert is triggered 1441, flagging the data as priority instance data, verification of communications availability is performed 1427. If communications are available, instance data 214 is transmitted to the Enterprise Collection Center 100. In the event that communications are not available 1427 at that time, the External Task Manager 142 continues to monitor for the detection of an open communication line 203 with which to transmit the instance data 214 to the Enterprise Collection Center 100.

If it is determined 1438 that the type of piracy being performed is disc, internet or screener piracy, verification of resident advertisements 1431 is performed. If advertisements are resident 1431 on the chip, on the media or in the content with the External Task Manager 142 implemented, the skip and fast forward functions are disabled 1432, advertisements are played uninterrupted 1433 and instance data is captured 1434. Verification of communications availability is performed 1427 and if communications are available, instance data 214 is transmitted to the Enterprise Collection Center 100. If communications are not available 1427 at that time, the External Task Manager 142 continues to monitor for the detection of an open communication line 203 with which to transmit the instance data 214 to the Enterprise Collection Center 100.

In the event that no commercials exist or that commercials exist but are not playable at the time, such as in the case of corruption, play of the media and/or content can be stopped 1437 or allowed 1436. It is the inventors' opinion that play values such as this be set not by the inventor, but by those most affected by piracy, the motion picture, recording and software industries, artists and copyright owners.

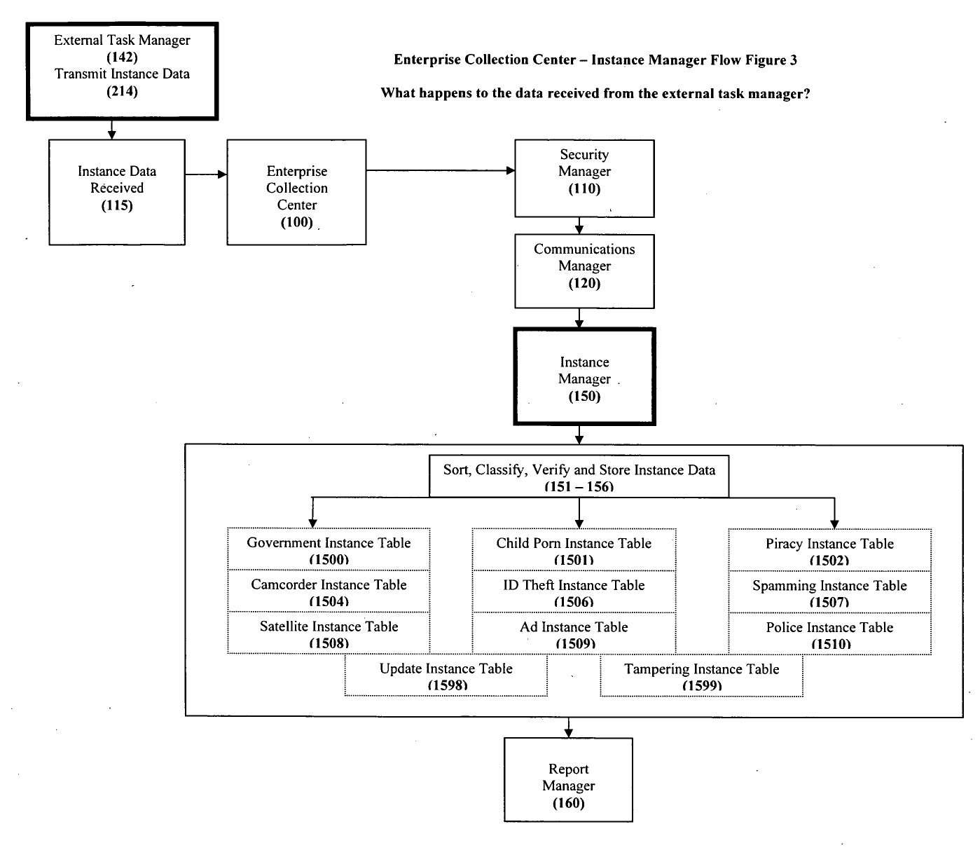

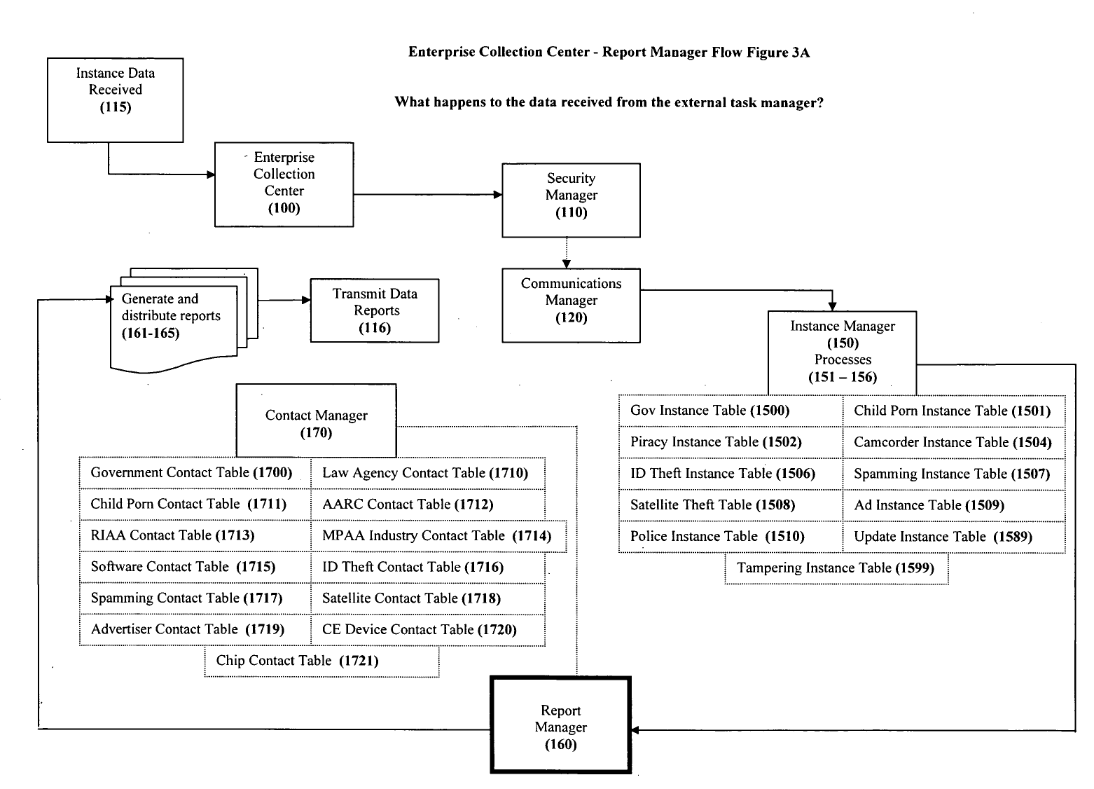

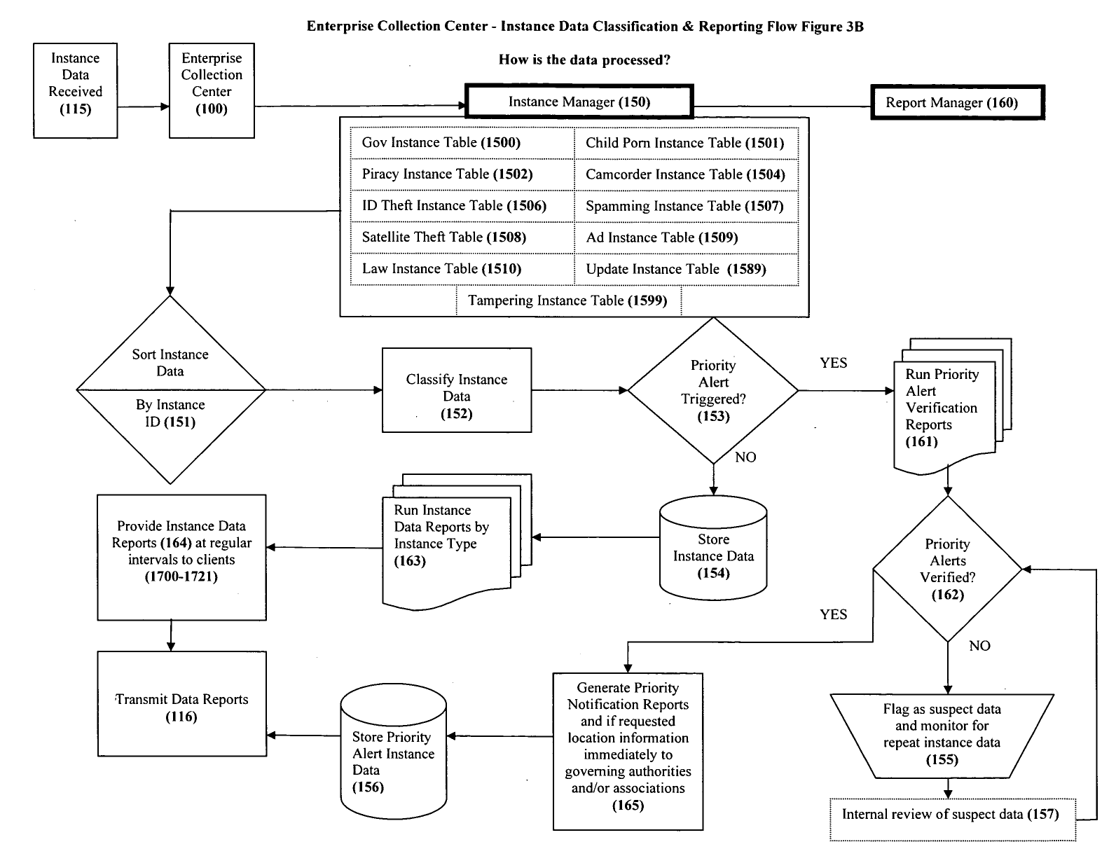

Referring next to FIG. 3, a block diagram illustrating a process for receiving 115 the instance data captured and transmitted 214 from the External Task Manager 142 at the Enterprise Collection Center 100 Instance Manager 150 for classification processing 151-156 and forwarding to the Report Manager 160. In one embodiment, the instance data is received 115 at the Enterprise Collection Center 100 via the Security Manager 110 and the Communications Manager 120 for receipt by the Instance Manager 150. The Instance Manager 150 processes 151-156 the instance data and forwards instance data to the Report Manager 160. The Instance Manager 150 processes 151-156 are further described and will become more apparent in FIG. 3B.

Referring now to FIG. 3A, a block diagram illustrates a process for generating and distributing processed instance data reports and notifications. In one embodiment, the instance data is received 115 at the Enterprise Collection Center 100 via the Security Manager 110 and the Communications Manager 120 for receipt by the Instance Manager 150. The Instance Manager 150 processes 151-156 the instance data and forwards instance data to the Report Manager 160. The Report Manager 160 pulls contact and datasets identifier information from the Contact Manager 170 for use in the generation and distribution 161-165 of the reports and transmission 116 of the reports. The Report Manager 160 processes 161-165 are further described and will become more apparent in FIG. 3B.

Referring next to FIG. 3B, a flow diagram illustrating a process of sorting, classifying and reporting instance data captured and received 115 at the Enterprise Collection Center 100 Instance Manager 150, as described in FIG. 3. Instance data is sorted 151, classified 152 and checked for priority alert flagging 153. Instance data not flagged, as priority alert data is stored 154 and queued for report processing 163 by the Report Manager 160 for distribution 164 and transmitting 116 to the clients 1700-1721 at client defined pre-determined intervals.

Instance data flagged as priority alert data 153 is immediately forwarded to the Report Manager 160 for priority alert verification 161 report generation. Priority alerts are then verified 162 by the Enterprise Collection Center 100 staff and generation of priority notifications and reporting 165 is performed, priority alert instance data is then stored 156 and the reports are transmitted 116 to the clients 1700-1721.

In the event that a priority alert cannot be verified 162, priority data is flagged as suspect and monitored 155 and reviewed 157 by the Enterprise Collection Center 100 staff for repeat instance capturing and reporting. The flagging if priority data as suspect data 155 enables the Enterprise Collection Center 100 staff to ensure accuracy in priority notifications 165 and to monitor highly suspect instance data 155 for new and emerging technological crimes and the methods in which they are being performed.

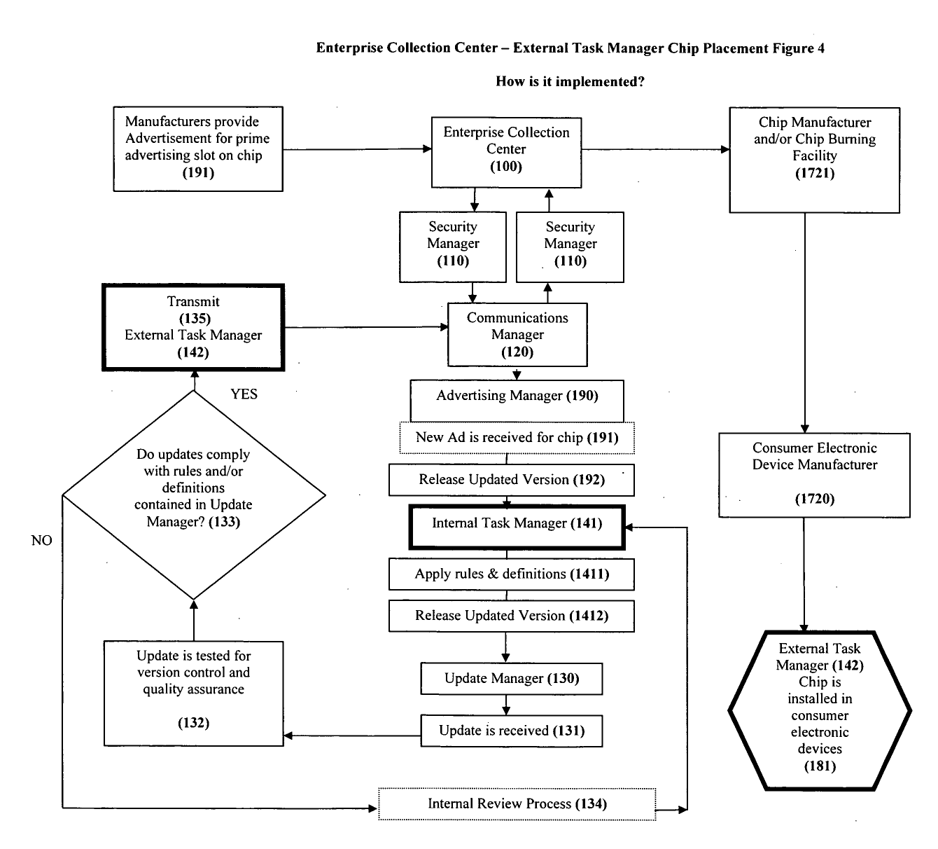

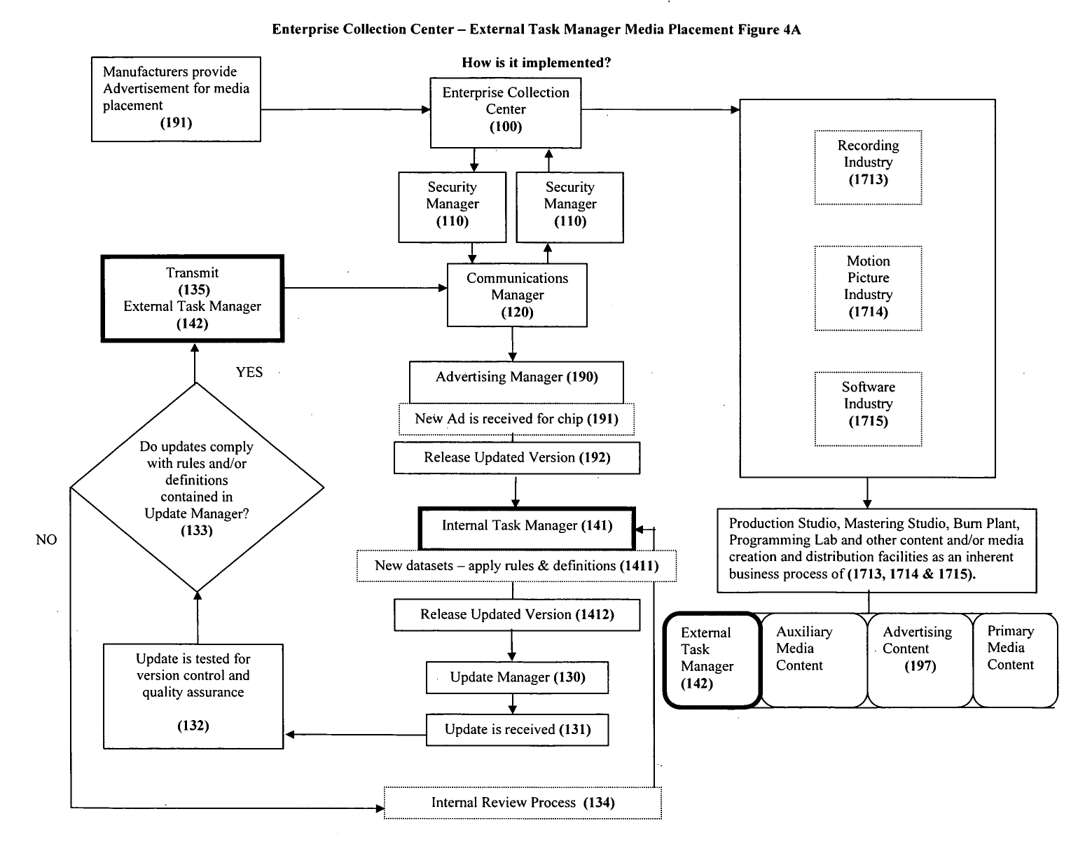

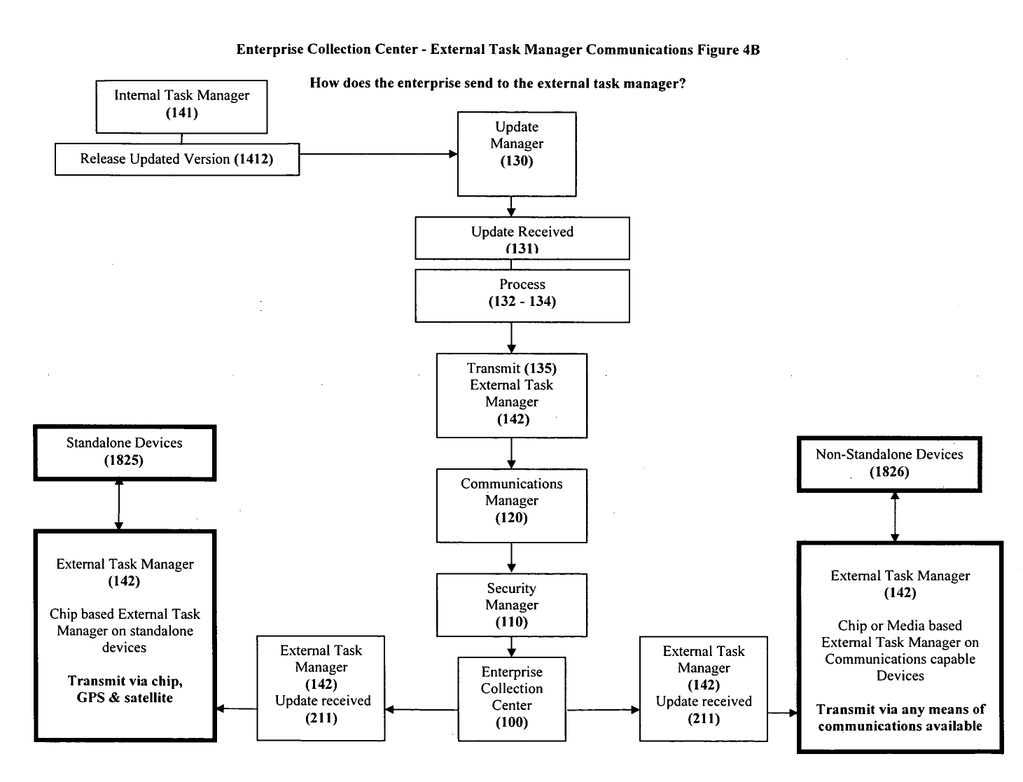

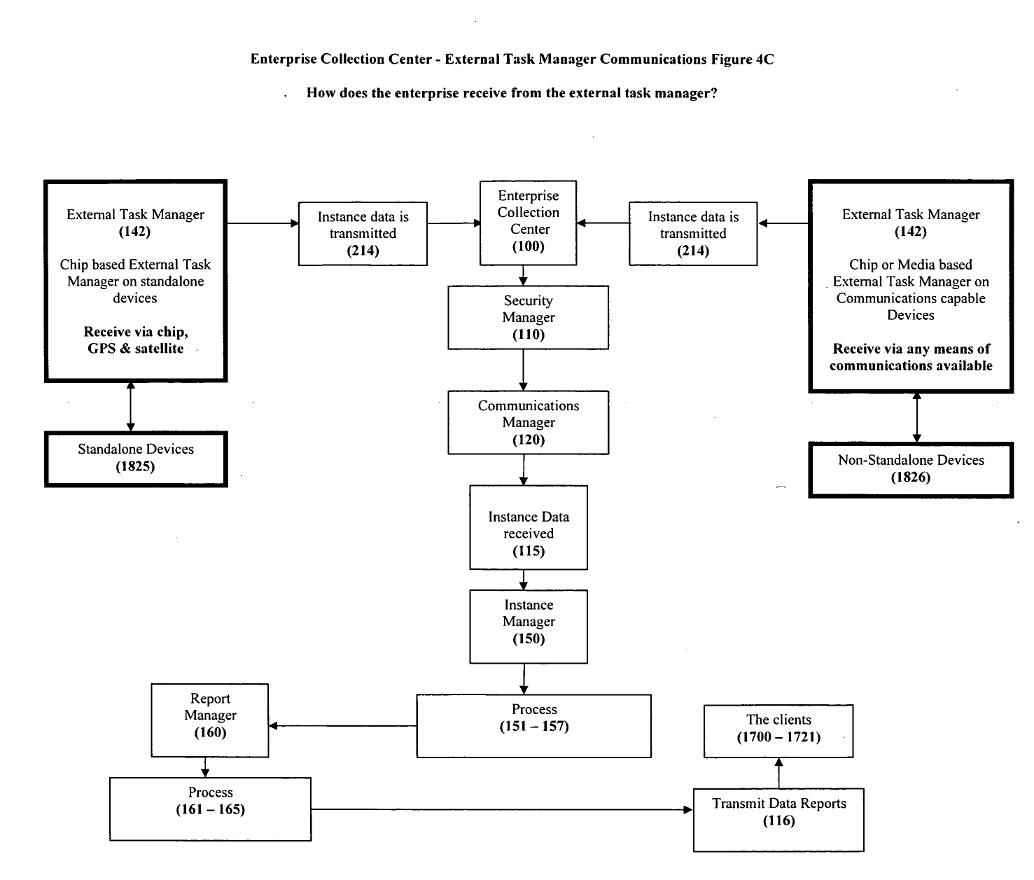

Referring next to FIG. 4, a flow diagram illustrates a process of incorporating and implementing the External Task Manager 142 onto one or more chips for inclusion in consumer electronic devices, as referenced in FIG. 1C. In one embodiment, the External Task Manager 142 is provided by the Enterprise Collection Center 100, via the Internal Task Manager 141, Update Manager 130, Communications Manager 120 and the Security Manager 110, to the chip manufacturer or to a chip burn facility 1721 for placement onto the chip. The External Task Manager 142 chip is then provided to the consumer electronic device manufacturers 1720 for installation in consumer electronic devices 181.

The Internal Task Manager 141 releases an updated version 1412 of the software/firmware instruction rules and definitions 1411 for use in the External Task Manager 142. The updated version is then released 1412 for receipt 131 at the Update Manager 130. The Update Manager 130 then performs version control processing and quality assurance testing 132 and compliance verification 133, prior to transmitting 135 the External Task Manager 142, to Chip Manufacturers and/or Chip Burn Facilities 1721, for placement onto the chip. The Chip Manufacturers and/or Chip Burn Facilities then forward the External Task Manager 142 chip to the Consumer Electronic Device Manufacturers 1720 for installation in consumer electronic devices 181.

Another embodiment includes a process for the inclusion of advertisements that are first received 191 at the Enterprise Collection Center 100 via the Security Manager 110 and the Communications Manager 120 for receipt 191 by the Advertising Manager 190. The Advertising Manager then processes and releases the updated advertisements 192 to the Internal Task Manager 141. The Internal Task Manager 141 applies the software/firmware instruction rules and definitions 1411 for use on the External Task Manager 142 and releases an updated version 1412 to the Update Manager 130. The Update Manager 130 receives the updated version 131, processes and test for version control and quality assurance 132, and verifies the compliance 133 of the update prior to initiating transmission 135 of the External Task Manager 142 to the chip manufacturers and burn facilities 1721.

Another embodiment of the system, method and apparatus comprises the Enterprise Collection Center 100 entailing the inclusion of a process and facility in which to program and burn the External Task Manager 142 onto the chips. In this embodiment the Enterprise Collection Center 100 would then provide the chips directly to the consumer electronic device manufacturers 1720 for installation in consumer electronic devices 181.

Referring now to FIG. 4A, a flow diagram illustrates a process of incorporating and implementing the External Task Manager 142 onto media or into content for use in consumer electronic media playing devices, as detailed in FIG. 1C. In one embodiment the Enterprise Collection Center 100 provides the External Task Manager 142 to the motion picture industry 1714, recording industry 1713 and/or software industry 1715. Those industries 1713-1715 then provide it to the various content and media creation and distribution business facilities inherent in the recording industry 1713, motion picture industry 1714 and the software industry 1715, for placement of the External Task Manager 142 onto media and into content.

In another embodiment the Internal Task Manager 141 releases an updated version 1412 of the software/firmware instruction rules and definitions 1411 for use in the External Task Manager 142. The updated version is then released 1412 for receipt 131 at the Update Manager 130. The Update Manager 130 then performs version control processing and quality assurance testing 132, verifies compliance 133 prior to transmitting 135 the External Task Manager 142 to the recording industry 1713, the motion picture industry 1714 and the software industry 1715, for placement onto the media and into the content. Those industries 1713-1715 then forward the External Task Manager 142 to the various content and media creation and distribution business facilities, inherent in the recording industry 1713, motion picture industry 1714 and the software industry 1715, for implementation on media and into content.

Another embodiment includes a process for the inclusion of advertisements that are first received 191 at the Enterprise Collection Center 100 via the Security Manager 110 and the Communications Manager 120 for receipt 191 by the Advertising Manager 190. The Advertising Manager 190 then processes and releases the advertisements 192 to the Internal Task Manager 141. The Internal Task Manager 141 applies the software/firmware instruction rules and definitions 1411 for use on the External Task Manager 142 and releases an updated version 1412 to the Update Manager 130. The Update Manager 130 receives the updated version 131, processes and test for version control and quality assurance 132, and verifies the compliance 133 of the update prior to initiating transmission 135 to the motion picture industry 1714, recording industry 1713 and software industry 1715.

Another embodiment of the system, method and apparatus comprises the Enterprise Collection Center 100 providing the External Task Manager 142 directly for placement to the content and media creation and distribution facilities inherent in the recording 1713, motion picture 1714 and the software industries 1715.

Referring next to FIG. 4B, a block diagram illustrating a process and method for communications from the Enterprise Collection Center 100, to chip, media and content based External Task Managers 142 installed or being utilized on or in either communications capable 1826 or non-communications capable standalone 1825 consumer electronic devices.

The Internal Task Manager 141 releases an updated version 1412 to the Update Manager 130. The update is received 131 and processed 132-134 by the Update Manager 130, prior to initiating transmission of the updated version 135 to the External Task Manager 142. The update is transmitted via the Communications Manager 120 and the Security Manager 110 and received 211 at the External Task Manager 142. In one embodiment, the External Task Manager 142 communicates via any communications form or mean that the consumer electronic device 1826 is capable, in which the External Task Manager 142 chip is installed or the External Task Manager 142 media or content is being utilized.

In another embodiment, the External Task Manager 142 communicates via the GPS and satellite communications capabilities inherent in the chip, thus ensuring External Task Manager 142 communications at all times on both communications capable consumer electronic devices and non-communications capable standalone 1825 consumer electronic devices. Chip based External Task Managers 142 can also utilize any other form or means of communications capabilities of the device in which the External Task Manager 142 chip is installed.

At this time, the media and content based External Task Managers 142 are not GPS capable and therefore may be limited to the communications capabilities of the device in which it is being utilized. It is noted that a person of ordinary skill in the art of GPS and related satellite communication technology will understand that GPS systems are a form of communication systems that transmit location information via inherent programmable communications to a GPS specific satellite. The inherent programmable communications capability of the chip utilized enables the Applicant to program communications for transmission of the data collected to another satellite, i.e. government secure satellite or third party satellite provisioning.

Such a capability has been confirmed by the manufacturers of the chip, and as at present day cannot ensure media or content based External Task Manager 142 communications capabilities in standalone devices 1825. This is however, anticipated to be resolved upon implementation of the External Task Manager 142 chip in consumer electronic devices, and through further research and development of the media and content based External Task Manager 142 digital communications capabilities and features.

Referring next to FIG. 4C, a block diagram illustrating a process and method for communications from the chip, media and content based External Task Manager 142 installed or being utilized in either communications capable 1826 or non-communications capable standalone 1825 consumer electronic devices, to the Enterprise Collection Center 100.

Instance data is transmitted 214 from the External Task Manager 142 to the Enterprise Collection Center 100 and received via the Security Manager 110 and the Communications Manager 120 for receipt 115 at the Instance Manager 150. The Instance Manager 150 then processes the instance data 151-157 received from the External Task Manager 142 and forwards the processed 151-157 instance data to the Report Manager 160 for notification and report generation processing 161-165 and distribution 116 to the clients 1700-1721.

In one embodiment, the External Task Manager 142 communicates via any communications form or means that the consumer electronic device 1826 is capable, in which the External Task Manager 142 chip is installed or the External Task Manager 142 media or content is being utilized.

In another embodiment, the External Task Manager 142 communicates via the GPS and satellite communications capabilities inherent in the chip, thus ensuring External Task Manager 142 communications at all times on both communications capable consumer electronic devices 1826 and non-communications capable standalone 1825 consumer electronic devices. Chip based External Task Managers 142 can also utilize any other form or means of communications capabilities of the device in which the External Task Manager 142 chip is installed.

At this time, the media and content based External Task Managers 142 are not GPS capable and therefore may be limited to the communications capabilities of the device in which it is being utilized (see explanation about GPS communications stated hereinabove). And as such at present day, cannot ensure media or content based External Task Manager 142 communications capabilities in standalone devices 1825. This is however, anticipated to be resolved upon implementation of the External task Manager 142 chip in consumer electronic devices, and through further research and development of the media and content based External Task Manager 142 digital communications capabilities and features.

Referring next to FIG. 5, a block diagram discloses a process of receiving and managing initiation and device level information at the Enterprise Collection Center 100 Device Manager 180. In one embodiment the External Task Manager 142 resident on one or more chips, on media or in content is activated for the first time, sending an activation ping 119 to the Enterprise Collection Center 100 via the Security Manager 110 and the Communications Manager 120. The Communications Manager 120 verifies if the incoming transmission is a first time activation ping 121, and logs activation information 122 in the activation table 1221.

In another embodiment, datasets are received 113 from the device manufacturers 1720 and chip manufacturers and burn facilities 1721 at the Enterprise Collection Center 100 via the Security Manager 110 and the Communications Manager 120. The Communications Manager 120 verifies if the form of communication is a first time activation ping 121. If the incoming transmission is not a first activation ping, the incoming transmission is qualified and routed 125 to the Device Manager 180. Datasets that are received 113 at the Device Manager 180 are processed through inventory and materials management 186-189 processes, then reports are generated for internal and external use by the Report Manager 160. An updated version 182 of key information is released to the Task Manager 140, for use by the Internal Task Manager 141.

Referring next to FIG. 5A, a block diagram discloses a process of receiving 113 and managing advertisements from the advertisers 1719 to the Enterprise Collection Center 100 via the Security Manager 110 and the Communications Manager 120 for receipt 191 at the Advertising Manager 190. In one embodiment, datasets are received 113 from the advertisers 1719 at the Advertising Manager 190. The Advertising Manager receives the datasets 191 and performs the ad management process 193-196, then reports are generated for internal and external use by the Report Manager 160. An updated version 192 of key information is released to the Task Manager 140, for use by the Internal Task Manager 141.

Referring next to FIG. 5B, a block diagram discloses a process of authenticating incoming transmissions 1101 to the Enterprise Collection Center 100. In one embodiment, an incoming transmission 1101 is received at the Enterprise Collection Center 100 via the Security Manager 110 and the Communications Manager 120. The Security Manager 110, verifies identification 1102 and authenticates 1103 the incoming transmission 1101, allowing the transmission of datasets received 113 or instance data received 115, to occur if identification 1102 and authentication 1103 are successful. In the event that either identification 1102 or authentication 1103 is unsuccessful, instance data of the attempted transmission is capture 123 and communications is terminated 124. Identification 1102 and authentication are performed using the Security Manager 110 identification table 1104, and the Communications Manager 120 activation table 1221.

In operation, the present invention performs at least one of the algorithms listed hereinbelow.

### Algorithms Sorted by Illicit Use

### Child Pornography: Chip Algorithm

A database of known child pornography web-sites is obtained through an association such as Calgary Police Services Technical Crime Unit, CyberTipLine.Com or ChildAbuse.Org. This database is then stored in the memory of the External Task Manager chip. The child pornography detection algorithm programmed on the chip is as follows:

For each detection instance of a known child pornography web-site is being accessed, capture and report the following base information when the pre-determined number of instances has been captured:
Instance Id
Chip serial Id
Unique System Id
IP Address
URL accessed
File name/URL address accessed
File name/URL address downloaded
Priority Alert Trigger=0/1
Location information
Date/Time Stamp

Updates to the database and updates to the algorithm are performed on an as needed basis. This includes the addition of any other information authorities may need to be captured and reported.

### Algorithm & Reporting Process

Child pornography instance data is received, analyzed and classified. Suspect data is then flagged and reported to Cybertipline.com for further investigation. Persons viewing known child pornography web-sites will be directly identified by the hardware encoded address of the network adapter card installed in the PC they are using, regardless of whether they mask or cloak their movements while on the web. It is noted the present invention currently does not remove the cloaking and masking capabilities of the PC, i.e. the present invention does not actually remove or stop such capabilities from being utilized while they are on the web. Rather, the present invention identifies the actual PC in which the person is using the masking and cloaking technologies and reports the location of the PC to the Enterprise Collection Center 100.

It is noted that the present invention's algorithm and reporting process allows a person to continue using masking and cloaking tools while surfing child pornography websites, while the present invention captures the true IP address, the known child pornography website being viewed, any child pornography file download information, etc. Once captured, the instance data, the location information, and other pertinent unique computer identification information are then transmitted and reported to authorities through the Enterprise Collection Center 100.

### Spamming: Chip Algorithm

For each detection instance of an email being sent to mass email addresses and masking technology is used, capture and report the following base information when the pre-determined number of instances has been captured:
Instance Id
Chip Serial Id
Unique System Id
IP Address
Sending Email Address
Actual Email Address
Number of included email addressees
Masking=on/off
Date/Time Stamp

Updates to the chip are performed on an as needed basis. This includes the addition of any other information authorities may need to be captured and reported.

### Algorithm & Reporting Process

Spamming instance data is received, analyzed and classified. Suspect data is then flagged and reported to ISP provider for active monitoring and law enforcement agency for further investigation.

The algorithm and reporting process effectively determines whether a user is sending 5 or 10 emails per day to multiple persons in their address books, or whether a spammer is mailing out numerous mass emails to numerous and various persons from numerous and various email addresses. Once data is received from a system, the data is reviewed for consistency in receiving and sending email addresses, subject headings and number of instances of mass mailings.

### Online Identity Theft: Chip Algorithm

For each detection instance of Internet activity where a SSN/SIN, Credit Card number or Bank Account number and/or other industry defined confidential data set is being used, capture and report the following base information when the pre-determined number of instances has been captured:
Instance Id
Chip Serial Id
Unique System Id
IP Address
URL accessed
Institution Id
SSN/SIN used=yes/no
Credit Card Number used=yes/no
Bank Account number used=yes/no
Transaction number
SSL bit encryption active=yes/no
Priority Alert Trigger=0/1
Masking=on/off
Date/Time Stamp

Updates to the chip are performed on an as needed basis. This includes the addition of any other information authorities may need to be captured and reported.

### Algorithm & Reporting Process

Online identity theft instance data is received, analyzed and classified. Suspect data is then flagged and reported to associated institution and law enforcement agency for further investigation. For example, while it is common practice for a person on a PC to request or provide personal information, the personal information being requested or provided remains consistent for the person(s) using that PC. It is uncommon for the same PC to have numerous and repeated instances of requests or provisioning of personal information, whether the personal information is the same or different. Once the data is received from a system, data is reviewed for inconsistencies, such as repeated instances of requests or provisioning of the same or different person(s) private information to or from the same web sites, such as government, credit or financial institutions.

### Piracy: Camcorder Piracy

As previously mentioned, Camcorder piracy is one of the main methods in which to obtain a copy of premier release digital content to use in the form of disc piracy for mass replication and sale. Three algorithms exist for Camcorder piracy. There are two algorithms programmed onto the chip, one specifically for frequency scrambling, the other for chip anti-tampering, and a third algorithm contained in the Enterprise Collection Center application. The two algorithms programmed directly onto the chip are unique and for use only on the BlackFin ADSP-BF561 chip for use in theatre projection systems.

In operation, camcorder frequency signals occurring within the confines of a theatre are detected and scrambled by a chip installed on the theatre's projection equipment. Detection occurs via the chip that listens for “unauthorized or unknown” frequencies and if detected, scrambles the frequency, leaving the camcorder silently recording white noise and triggers a priority alert, transmitting instance data immediately to the enterprise collection center 100.

### Chin Algorithms

For each detection instance of camcorder frequency, trigger frequency scrambler, capture the following information and immediately report for each and every single instance capture:
Instance ID
Chip Serial ID
Frequency used
Priority Alert Trigger=0/1
Location information
Date/Time Stamp

This solution will stop camcorder piracy through the GPS and frequency scrambling capabilities of the chip with the above algorithm, and the priority alert trigger algorithm in the Enterprise Collection Center application. The chip listens for a foreign signal and then:
1.) Triggers the frequency scrambler to run, scrambling the camcorder with the end result of nothing but white noise or static being recorded.
2.) Performs immediate GPS transmittal of instance and location information.

### Anti-Tampering Algorithm

For every initiation of direct service to the chip, verify origin against security list. If origin=unknown, record to memory access details, report using priority alert trigger and disable chip. The chip is not only programmable, but also has inherent power management features, meaning it can be programmed to shut down the system in the event of a security breach. The device is returned to a functional state once tampering details have been investigated and cleared.

### Algorithm & Reporting Process

Camcorder piracy instance data is received, analyzed, classified and a priority alert is triggered for immediate electronic and/or verbal reporting of each single detection instance so as to allow law enforcement the opportunity to enter the theatre and arrest the criminal.

### Disc, Screener & Internet P2P File Sharing Piracy

As provided with Camcorder piracy, the desire was to develop a method in which to immediately address Disc, Screener & Internet P2P file sharing piracy. These however are the more complex forms of piracy and therefore require a more comprehensive methodology to successfully combat them. All three forms of piracy utilize the same following processes, logic and algorithms.

### Processes

I have developed and am recommending a two-stage solution to address and combat piracy. In keeping with this document, the detection, capturing and accurate reporting of piracy instances occurring is paramount to stopping the illicit uses of technology for piracy purposes, and therefore is one of the recommended stages. The other stage is to re-define the process of dealing with P2P file sharing, thereby turning it into a financially viable, new method of distribution that has the ability to generate a large revenue generation stream and meets consumer demand.

The reported average amount of time it takes to fully implement new technology into the consumer electronic industry is 2-3 years. The chip utilized to detect, capture and report instances of technological crime occurrences, is meant to be implemented in all consumer electronic devices, which are Internet capable and/or contain a CD/DVD/MP3 and/or any other audio/video playing devices. This implementation should not be expected to be in full production for a two to three year period. With the rapidly escalating rise in piracy, two to three more years could easily equal hundreds of billions or more in lost revenue, drastic cost cutting measures and layoffs, further damaging industries already strongly affected, and the overall economy.

For this reason I have included a Stage one routine in my methodology that begins with the understanding and re-defining P2P file sharing as a new distribution method. P2P file sharing should then be handled as most others audio/video publicly shared or distributed content, which is through the distribution of included and/or added in commercial advertising content. In order to do this Industry must approach manufacturers with the means to digitally master, and/or pre-master, and/or press and/or embed commercials into songs, movies, games and software, etc.

Stage one involves the inclusion of the commercials with the digital content on the media. Stage one crime detection, capturing and reporting capability is limited to enable communication availability on the device being used. Stage one strengths are the revenue generation stream creation and a deterrent to consumers using pirated content. Upon Stage Two chip programmed software/firmware instructions implementation, industry can further ensure manufacturers the following abilities, including but not limited to the forced uninterruptible playing of the commercials, remote commercial updating, accurate timely reporting of demographic target audience information and the ability to detect, capture and report instances of piracy.

### Stage One Algorithms

There are 3 algorithms in total for mastering, programming, and/or embedding directly onto distribution media discs, including but not limited to, CD's, VCD's and DVD's, containing commercial advertising.

### Media Algorithms

Three algorithms are programmed onto the media, each containing the same base algorithmic logic, as documented below. Industry specific capturing requirements have been broken out and identified as industry specific data capture requirements.

For each detection instance of copyright content being played from a non-distribution or blank CD/DVD, play commercials at pre-determined interval. Detection of a non-distribution or blank piece of media containing copyrighted content occurs by determining the status of one or more of the follows fields:
ISRC Id indicates copyrighted material
Disc Media Serial number (CD/DVDNCD etc.) indicates blank
Copyright Content information
Sub-code Channel information
Original Id=0/1
Commercial Id
Date/Time Stamp
*Priority Alert Trigger=0/1

*If enabled communications are available and more than x replication instances of the same copyrighted content have occurred, immediately report and send Priority Alert Trigger. It must be noted that GPS capabilities reside in the chip and therefore this portion of the algorithm is solely dependent on availability of enabled communications. Also location information cannot be accurately provided until Stage Two chip implementation occurs. Capabilities at this level are more for activity monitoring and trend identification.

It is noted, through media sub channel information, content property values and commercial property values, the external task manager 142 recognizes illegal use of copyrighted content on a load event.

### Motion Picture Algorithm Requirements

Uses the above base algorithm plus the capture and reporting of the following and/or any other industry specific data:
Motion Picture Id
Studio Id
Title Id

This algorithm is initially designed to play the commercials at 15-18 minute intervals.

### Recording Industry Algorithm Requirements

Uses the above base algorithm plus the capture and reporting of the following and/or any other industry specific data:
Recording Company Id
Artist Id
Title Id

This algorithm is initially designed to play the commercials at the beginning of each track.

### Software Industry Algorithm Requirements

Uses the above base algorithm plus the capture and reporting of the following and/or any other industry specific data:
Software Company Id
Application/Game Id
OEM number

This algorithm is initially designed to play the commercials at 15-18 minute intervals.

### Stage Two Algorithms

Stage two of the piracy solution, crime detection, comes upon implementation of the chip technology into consumer electronic devices, as previously described above.

### Chip Algorithms

Four algorithms are programmed onto the chip, three containing the same base algorithmic logic, as documented below. Industry specific capturing requirements have been broken out and identified as industry specific data capture requirements. The fourth algorithm is specific to chip anti-tampering and is uniquely programmed.

Prime advertising slots contained directly onto the chip are offered to manufacturers for use. These prime advertising slots are used in the event that commercials contained on the disc media are corrupt, disabled or non-existent and/or in the event that a piece of pirated copyrighted content created prior to this technology is inserted into a device. In instances of these events commercials will be played at the pre-determined time interval directly from the chip, making this technology reverse portability capable.

A Priority Alert Trigger routine is also included within the base algorithmic logic of the chip that monitors data captured for repeated replication instances of the same song, movie or software OEM number. Once x number of replications is obtained, data is immediately reported and forwarded to law enforcement and/or the associated industry agency.

For each detection instance of copyright content being played from a non-distribution or blank CD/DVD, disable fast-forward & skip capability then, play commercial contained on media. If no commercial exists or exists but is not playable, then disable fast-forward & skip capability and play commercial from chip, then capture the following information and report the information when the pre-determined amount of instances has been captured:
Instance Id
Unique System Id
IP Address
SRC Id
Disc Media Serial number (CD/DVDNCD, etc.)
Sub-code Channel information
Original Id=0/1
Commercial Id
Industry/Association Id
Copyright Content Id
Priority Alert Trigger=0/1
Location information
Date/Time Stamp

Firmware updates to the chip are performed on an as needed basis. This includes the addition of any other information that may need to be captured and reported.

### Motion Picture

Uses the above base algorithm plus the capture and reporting of the following and/or any other industry specific data:
Motion Picture Id
Studio Id
Title Id

This algorithm is initially designed to play the commercials at 15-18 minute intervals. Firmware updates to the chip are performed on an as needed basis. This includes the addition of any other information that may need to be captured and reported.

### Recording Industry

Uses the above base algorithm plus the capture and reporting of the following and/or any other industry specific data:
Recording Company Id
Artist Id
Title Id

This algorithm is initially designed to play the commercials at the beginning of each track. Firmware updates to the chip are performed on an as needed basis. This includes the addition of any other information that may need to be captured and reported.

### Software Industry

Uses the above base algorithm plus the capture and reporting of the following and/or any other industry specific data:
Software Company Id
Application/Game Id
OEM number

This algorithm is initially designed to play the commercials at 15-18 minute intervals. Firmware updates to the chip are performed on an as needed basis. This includes the addition of any other information that may need to be captured and reported.

### Anti-Tampering Algorithm

For every initiation of direct service to the chip, verify origin against security list. If origin=unknown, record to memory access details, report intrusion details then disable power through the power management feature of the chip and display intrusion/tampering code on LED. This then forces the owner to call in and report the error and provide make, model and serial number of device. Device is returned to functional state once tampering details have been investigated and cleared.

### Algorithms & Reporting Process

Piracy instance data is received, analyzed, classified and a priority alert is triggered for immediate electronic and/or verbal reporting of repeated mass replications of any songs, movies or software OEM's.

The Priority Alert Trigger detection instances of mass replication occurrences and immediate reporting of highly suspect data allows law enforcement officials the opportunity to quickly respond directly to the disc piracy location. This class identifies Disc piracy and Screener piracy.

Content usage information is used to identify viewing/listening/usage information and is reported to one of the following:
AARC for royalty collection and disbursement from industry for the advertising time slot played with the copyright owners and artists content;
Motion Picture industry or other association (possibly AARC) for royalty collection and/or disbursement for advertising time played with copyrighted content;
BSA or other affiliated software entertainment/application association for lost revenue collection, disbursement, tracking and trending

This class of data identifies P2P file sharing instances as well as instances of mass replicated pirated goods in use at the consumer level. Commercial viewing statistics are used to classify and report viewing/listening instances and demographic target audience data to commercial advertising providers.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what is desired to secure by Letters Patent of the United States is:

1. A computer program product for enabling a consumer electronic device to detect instances of technological crimes occurring through the use of electronic technology, said computer program product comprising:
software instructions for enabling the consumer electronic device to perform predetermined operations;
firmware instructions for enabling the consumer electronic device to perform predetermined operations; and
at least one computer readable medium bearing said software and firmware instructions, said predetermined operations including the steps of
(a) detecting an instance of a technological crime occurring on the electronic technology,
(b) identifying a type of said technological crime instance
(c) capturing said technological crime instance data,
(d) reporting of said technological crime instance data to the Enterprise Collection Center, and
(e) provisioning of a location of said technological crime instance to at least one interested entity;
wherein the interested entity can quickly and efficiently investigate said technological crime instance.

2. A computer system adapted for detecting, identifying, capturing and reporting instances of technological crimes, said computer system comprising:
an Enterprise Collection Center software application residing on a server for performing predetermined operations;
a computer readable medium electronically attached to or inserted into an electronic device, said electronic device being remotely located from said Enterprise Collection Center software application, said computer readable medium bearing software/firmware instructions, the predetermined operations including the steps of
(a) detecting a technological crime instance occurring on the electronic technology,
(b) identifying a type of said technological crime instance,
(c) capturing said technological crime instance, and
(d) reporting a location of said technological crime instance to at least one interested entity; and a communications link for transmitting data between said computer readable medium and said enterprise collection center such that said technological crime instance can be remotely and automatically detected during real-time and thereby enable the interested entity to quickly and efficiently investigate said technological crime instance.

3. The computer program product of claim 2, wherein one said electronic medium comprises: a communication capable computer readable medium.

4. The computer program product of claim 2, wherein another said electronic medium comprises: a hardware chip electronically attached to a non-communication stand alone electronic device.

5. A software/firmware instruction set embodied in a transmission medium for enabling an electronic device to detect instances of technological crimes occurring through the use of electronic technology, said software/firmware instructions comprising:
readable software/firmware instruction code for detecting a technological crime instance occurring on an electronic device,
readable software/firmware instruction code for identifying a type of said technological crime instance, and
readable software/firmware instruction code for reporting and provisioning of a location of said technological crime instance to at least one interested entity;
wherein the interested entity can quickly and efficiently investigate said technological crime instance.

6. A method for detecting, identifying, capturing, locating and reporting instances of technological crimes occurring through the use of consumer electronic technology, said method comprising the steps of:
providing an enterprise collection center for creating and managing crime detection rules, definitions and instructions, said enterprise collection center comprising at least one manager module selected from the group comprising
a Security Manager module;
a Communications Manager module;
an Update Manager module;
a Task Manager module;
an Instance Manager module;
a Report Manager module;
a Contact Manager module;
a Device Manager module; and
an Advertising Manager module.

7. The method according to claim 6, wherein said Task Manager module comprises:
an Internal Task Manager; and
an External Task Manager.

8. The method according to claim 7, further comprising the step of said Task Manager receiving datasets from the clients for use in Internal Task Manager processing.

9. The method according to claim 8, wherein said Internal Task Manager receives datasets for use in creating, maintaining and managing the software/firmware detection and capturing rules, definitions and instruction, and communicating an updated version of the rules, definitions and instructions to the Update Manager.

10. The method according to claim 9, wherein said Update Manager receives the updated version for version control and quality assurance testing prior to communicating the updated version to the External Task Manager.

11. The method according to claim 10, wherein said External Task Manager resides on one or more chips in consumer electronic devices, on media or within content and receives and executes the software/firmware detection rules, definitions and instructions, captures the instance data and communicates the instance data back to the Enterprise Collection Center.

12. The method according to claim 11, wherein said Enterprise Collection Center Instance Manager module receives the captured instance data from the External Task Manager and sorts and classifies said instance data.

13. The method according to claim 6, wherein said Enterprise Collection Center Report Manager module reports and distributes instance data back to the clients.

14. The method according to claim 6, wherein said software/firmware rules, definitions and instructions detect child pornography instances, identity theft instances, spamming instances, disc, screener, camcorder and internet piracy instances, and satellite and broadcast theft instances.

15. The method according to claim 6, wherein said software/firmware rules, definitions and instructions identify child pornography instances, identity theft instances, spamming instances, disc, screener, camcorder and internet piracy instances, and satellite and broadcast theft instances.

16. The method according to claim 6, wherein said software/firmware rules, definitions and instructions capture child pornography instances, identity theft instances, spamming instances, disc, screener, camcorder and internet piracy instances, and satellite and broadcast theft instances.

17. The method according to claim 6, wherein said software/firmware rules, definitions and instructions locate child pornography instances, identity theft instances, spamming instances, disc, screener, camcorder and internet piracy instances, and satellite and broadcast theft instances.

18. The method according to claim 6, wherein said software/firmware rules, definitions and instructions report child pornography instances, identity theft instances, spamming instances, disc, screener, camcorder and internet piracy instances, satellite and broadcast theft instances.

19. The method according to claim 17, wherein said viewing or listening of enforced advertisements occurs if disc, screener or internet piracy instances are detected and identified.
